(19) United States
(12) Patent Application Publication
(10) Pub. No.: US 2007/0126932 A1
(43) Pub. Date: Jun. 7, 2007

(54) Systems and methods for utilizing idle display area

(76) Inventors: Kiran Bhat, Mountain View, CA (US); Anoop K. Bhattacharjya, Campbell, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/390,932

(22) Filed: Mar. 28, 2006

Related U.S. Application Data
(63) Continuation-in-part of application No. 11/294,023, filed on Dec. 5, 2005.

(51) Int. Cl. H04N 9/74; H04N 5/66

(52) U.S. Cl. 348/578; 348/739

(57) ABSTRACT

A surround visual field that has a characteristic or characteristics which relate to an audio/visual presentation is described. In one embodiment, the surround visual field is displayed in an area partially surrounding or surrounding the video content being displayed. This surround visual field may be comprised of a plurality of elements that further enhance the effect of the content being displayed. For example, one embodiment of the invention provides for elements within the surround visual field to move in relation to motion within the video content being displayed. Other characteristics of the video content may also be supplemented by the surround visual field or the surround visual field may be authored, at least in part, to correspond to the content itself. In embodiments, the surround visual field may be a rendering of a three-dimensional environment. In embodiments, one or more otherwise idle display areas may be used to display a surround visual field.

### CROSS-REFERENCE TO RELATED APPLICATIONS

This application is a continuation-in-part of and claims the priority benefit of co-pending and commonly assigned U.S. patent application Ser. No. 11/294,023, (Attorney Docket No. AP238HO), filed on Dec. 5, 2005, entitled “IMMERSIVE SURROUND VISUAL FIELDS,” listing inventors Kar-Han Tan and Anoop K. Bhattacharjya, which is incorporated by reference in its entirety herein.

This application is related to co-pending and commonly assigned U.S. patent application Ser. No.______, (Attorney Docket No. AP248HO) filed on the same day as the instant application and entitled “SYNTHESIZING THREE-DIMENSIONAL SURROUND VISUAL FIELD,” listing inventors Kiran Bhat, Kar-Han Tan, and Anoop K. Bhattacharjya, which is incorporated by reference in its entirety herein.

### BACKGROUND

A. Technical Field

The present invention relates generally to the visual enhancement of an audio/video presentation, and more particularly, to the synthesis and display of a surround visual field relating to the audio/visual presentation.

B. Background of the Invention

Various technological advancements in the audio/visual entertainment industry have greatly enhanced the experience of an individual viewing or listening to media content. A number of these technological advancements improved the quality of video being displayed on devices such as televisions, movie theatre systems, computers, portable video devices, and other such electronic devices. Other advancements improved the quality of audio provided to an individual during the display of media content. These advancements in audio/visual presentation technology were intended to improve the enjoyment of an individual or individuals viewing this media content.

An important ingredient in the presentation of media content is facilitating the immersion of an individual into the presentation being viewed. A media presentation is oftentimes more engaging if an individual feels a part of a scene or feels as if the content is being viewed “live.” Such a dynamic presentation tends to more effectively maintain a viewer's suspension of disbelief and thus creates a more satisfying experience.

This principle of immersion has already been significantly addressed in regards to an audio component of a media experience. Audio systems, such as Surround Sound, provide audio content to an individual from various sources within a room in order to mimic a real-life experience. For example, multiple loudspeakers may be positioned in a room and connected to an audio controller. The audio controller may have a certain speaker produce sound relative to a corresponding video display and the speaker location within the room. This type of audio system is intended to simulate a sound field in which a video scene is being displayed.

Current video display technologies have not been as effective in creating an immersive experience for an individual. Several techniques use external light sources or projectors in conjunction with traditional displays to increasing the sense of immersion. For example, the Philips Ambilight TV projects one of a set number of colored backlights behind the television. Such techniques are deficient because they fail to address the issue of utilizing a device's full display area when displaying content. Furthermore, current video display devices oftentimes fail to provide adequate coverage of the field of view of an individual watching the device or fail to utilize significant portions of a display. As a result, the immersive effect is lessened and consequently the individual's viewing experience is lessened.

Accordingly, what is desired are systems, devices, and methods that address the above-described limitations.

### SUMMARY OF THE INVENTION

An embodiment of the present invention provides a surround visual field, which relates to audio or visual content being displayed. In one embodiment of the invention, the surround visual field is synthesized and displayed on a surface that partially or completely surrounds a device that is displaying the content. This surround visual field is intended to further enhance the viewing experience of the content being displayed. Accordingly, the surround visual field may enhance, extend, or otherwise supplement a characteristic or characteristics of the content being displayed. One skilled in the art will recognize that the surround visual field may relate to one or more cues or control signals. A cue, or control signal, related to an input stream shall be construed to include a cue relate to one or more characteristics within the content being displayed including, but not limited to, motion, color, intensity, audio, genre, and action, and to user provided-input, including but not limited to, user motion or location obtained from one or more sensors or cameras, game device inputs, or other inputs. In an embodiment, one or more elements in the surround visual field may relate to a cue or cues by responding to said cue or cues.

In one embodiment of the invention, the surround visual field is projected or displayed during the presentation of audio/video content. The size, location, and shape of this surround visual field may be defined by an author of the visual field, may relate to the content being displayed, or be otherwise defined. Furthermore, the characteristics of the surround visual field may include various types of shapes, textures, patterns, waves or any other visual effect that may enhance the viewing of content on the display device. One skilled in the art will recognize that various audio/visual or projection systems may be used to generate and control the surround visual fiel; all of these systems are intended to fall within the scope of the present invention.

In one exemplary embodiment of the invention, the surround visual field may relate to motion within the content being displayed. For example, motion within the content being displayed may be modeled and extrapolated. The surround visual field, or components therein, may move according to the extrapolated motion within the content. Shapes, patterns or any other element within the surround visual field may also have characteristics that further relate to the content's motion or any other characteristic thereof.

In embodiments of the invention, a three-dimensional surround visual field may be synthesized or generated, wherein one or more elements in the surround field is affected according to one or more cues related to the input stream. For example, motion cues related to the displayed content may be provided to and modeled within a three-dimensional surround visual field environment. The surround visual field, or elements therein, may move according to the extrapolated motion within the content. Light sources, geometry, camera motions, and dynamics of synthetic elements within the three-dimensional surround visual field environment may also have characteristics that further relate to the input stream.

In embodiments, the surround visual field may be displayed in one or more portions of otherwise idle display areas. As with other embodiments, the surround visual field or portions thereof may be altered or change based upon one or more control signals extracted from the input stream. Alternatively or additionally, the surround visual field displayed in the otherwise idle display area may be based upon authored or partially-authored content or cues.

Although the features and advantages of the invention are generally described in this summary section and the following detailed description section in the context of embodiments, it shall be understood that the scope of the invention should not be limited to these particular embodiments. Many additional features and advantages will be apparent to one of ordinary skill in the art in view of the drawings, specification, and claims hereof.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is an illustration of a surround visual field system including a projector according to one embodiment of the invention.

FIG. 2 is an illustration of a television set with surround visual field according to one embodiment of the invention.

FIG. 3 is an illustration of a television set with surround visual field from a projector according to one embodiment of the invention.

FIG. 4 is an illustration of a television set with surround visual field from a projector and reflective device according to one embodiment of the invention.

FIG. 5 is a block diagram of an exemplary surround visual field controller in which a projected surround visual field relates to motion within. displayed content according to one embodiment of the invention.

FIG. 6 is a diagram of a successive frame pair and exemplary optical flow vectors between the pixels within the frame pair according to one embodiment of the invention.

FIG. 7 is a diagram of a successive frame pair and exemplary optical flow vectors between pixel blocks within the frame pair according to one embodiment of the invention.

FIG. 8 is a diagram illustrating a mathematical relationship between two pixels within a global motion model representative of motion between a frame pair according to one embodiment of the invention.

FIG. 9 is an illustrative representation of a calculated global motion model of motion between a frame pair according to one embodiment of the invention.

FIG. 10A is an example of a video frame and overlaid optical flow vectors according to one embodiment of the invention.

FIG. 10B is an example of the video frame and overlaid global motion model according to one embodiment of the invention.

FIG. 11 is an illustration showing the extrapolation of motion vectors outside a video frame according to one embodiment of the invention.

FIG. 12 is an example of a video frame, an overlaid global motion model on the video frame, and an extrapolated global motion model beyond the boundaries of the video frame according to one embodiment of the invention.

FIG. 13 illustrates an exemplary modified surround visual field element relative to motion according to one embodiment of the invention.

FIG. 14 illustrates an exemplary modified surround visual field element relative to multiple motion vectors according to one embodiment of the invention.

FIG. 15 is an illustration of an exemplary surround visual field related to motion within a video according to one embodiment of the invention.

FIG. 16 is a functional block diagram of an exemplary surround visual field controller in which a projected surround visual field receives one or more inputs, extracts cues or controls signals from the inputs, and uses those control signals to generate a surround visual field according to embodiments of the invention.

FIG. 17 is an illustration of method for computing pan-tilt-zoom components from a motion vector field according to an embodiment of the invention.

FIGS. 18A and 18B are illustrations of an exemplary surround visual field related to an input video stream according to an embodiment of the invention.

FIGS. 19A-D are illustrations of an exemplary surround visual field related to an input video stream according to an embodiment of the invention.

FIG. 20 is an illustration of an exemplary surround visual field related to an input image according to an embodiment of the invention.

FIGS. 21A and 21B are illustrations of exemplary displays in which portions of the display areas are unused.

FIG. 22 is an illustration of an exemplary surround visual field according to an embodiment of the invention.

FIG. 23 depicts exemplary surround visual fields according to embodiments of the invention.

### DETAILED DESCRIPTION OF THE PREFERRED EMBODIMENTS

Systems, devices, and methods for providing a surround visual field that may be used in conjunction with an audio/visual content are described. In one embodiment of the invention, a surround visual field is synthesized and displayed during the presentation of the audio/visual content. The surround visual field may comprise various visual effects including, but not limited to, images, various patterns, colors, shapes, textures, graphics, texts, etc. In an embodiment, the surround visual field may have a characteristic or characteristics that relate to the audio/visual content and supplement the viewing experience of the content. In one embodiment, elements within the surround visual field, or the surround visual field itself, visually change in relation to the audio/visual content or the environment in which the audio/visual content is being displayed. For example, elements within a surround visual field may move or change in relation to motion and/or color within the audio/video content being displayed.

In another embodiment of the invention, the surround visual field cues or content may be authored, and not automatically generated at viewing time, to relate to the audio/visual content. For example, the surround visual field may be synchronized to the content so that both the content and the surround visual field may enhance the viewing experience of the content. One skilled in the art will recognize that the surround visual field and the audio/visual content may be related in numerous ways and visually presented to an individual; all of which fall under the scope of the present invention.

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different systems and devices including projection systems, theatre systems, televisions, home entertainment systems, and other types of audio/visual entertainment systems. The embodiments of the present invention may also be present in software, hardware, firmware, or combinations thereof. Structures and devices shown below in block diagram are illustrative of exemplary embodiments of the invention and are meant to avoid obscuring the invention. Furthermore, connections between components and/or modules within the figures are not intended to be limited to direct connections. Rather, data between these components and modules may be modified, re-formatted, or otherwise changed by intermediary components and modules.

Reference in the specification to “one embodiment” or “an embodiment” means that a particular feature, structure, characteristic, or function described in connection with the embodiment is included in at least one embodiment of the invention. The appearances of the phrase “in one embodiment” or “in an embodiment” in various places in the specification are not necessarily all referring to the same embodiment.

C. Overview

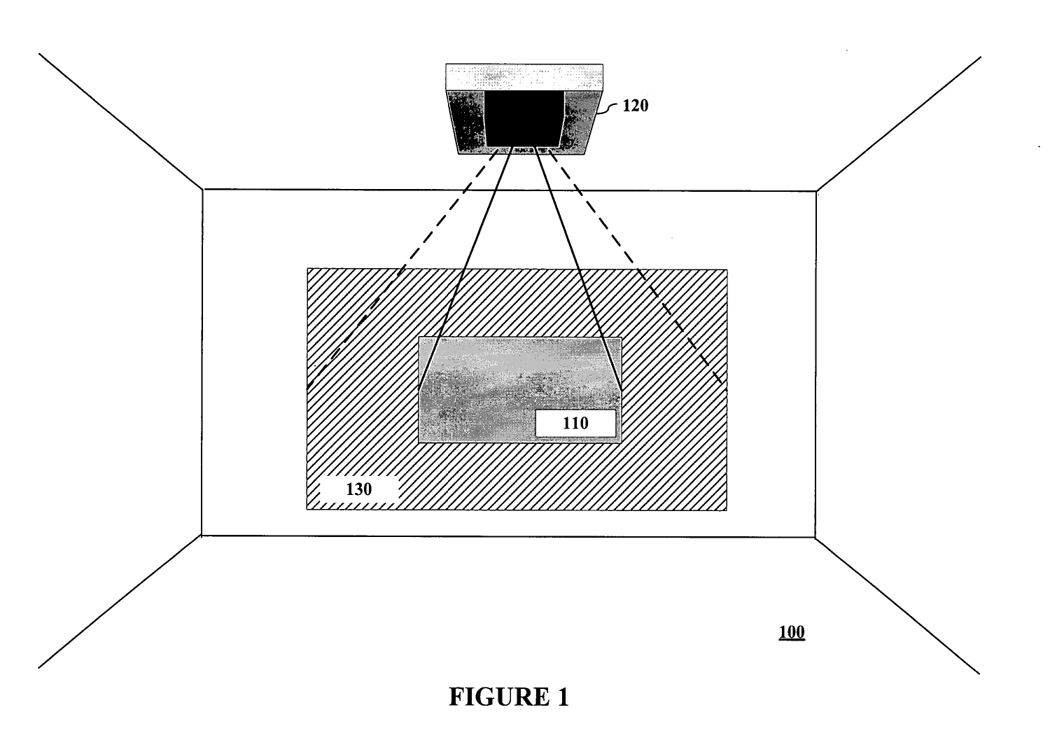

FIG. 1 illustrates a surround visual field display system that may be incorporated in a theatre or home video environment according to one embodiment of the invention. The system 100 includes a projector 120 that projects video content within a first area 110 and a surround visual field in a second area 130 surrounding the first area 110. The surround visual field does not necessarily need to be projected around the first area 110; rather, this second area 130 may partially surround the first area 110, be adjacent to the first area 110, or otherwise projected into an individual's field of view.

The projector may be a single conventional projector, a single panoramic projector, multiple mosaiced projectors, a mirrored projector, novel projectors with panoramic projection fields, any hybrid of these types of projectors, or any other type of projector from which a surround visual field may be emitted and controlled. By employing wide angle optics, one or more projectors can be made to project a large field of view. Methods for achieving this include, but are not limited to, the use of fisheye lenses and catadioptric systems involving the use of curved mirrors, cone mirrors, or mirror pyramids. The surround visual field projected into the second area 130 may include various images, patterns, shapes, colors, and textures, which may include discrete elements of varying size and attributes, and which may relate to one or more characteristics of the audio/video content that is being displayed in the first area 110. These patterns and textures may include, without limitation, starfield patterns, fireworks, waves, or any other pattern or texture.

In one embodiment of the invention, a surround visual field is projected in the second area 130 but not within the first area 110 where the video content is being displayed. In another embodiment of the invention, the surround visual field may also be projected into the first area 110 or both the first area 110 and the second area 130. In an embodiment, if the surround visual field is projected into the first area 110, certain aspects of the displayed video content may be highlighted, emphasized, or otherwise supplemented by the surround visual field. For example, particular motion displayed within the first area 110 may be highlighted by projecting a visual field on the object within the video content performing the particular motion.

In yet another embodiment of the invention, texture synthesis patterns may be generated that effectively extend the content of the video outside of its frame. If regular or quasi-regular patterns are present within a video frame, the projector 120 may project the same or similar pattern outside of the first area 110 and into the second area 130. For example, a corn field within a video frame may be expanded outside of the first area 110 by generating a pattern that appears like an extension of the corn field.

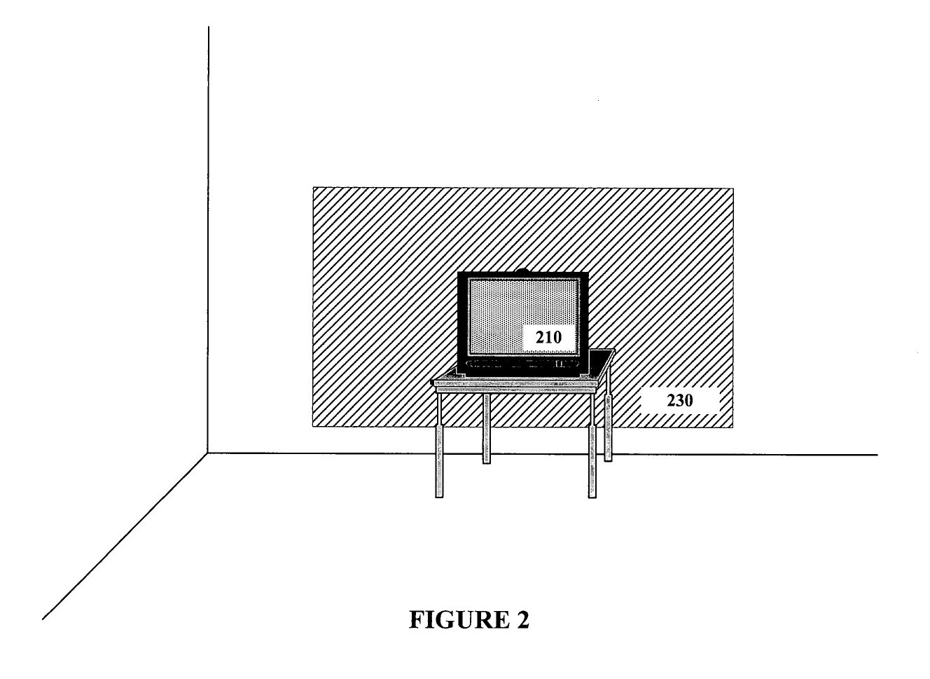

FIG. 2 illustrates a surround visual field in relation to a television set according to one embodiment of the invention. A television set having a defined viewing screen 210 is supplemented with a surround visual field projected on a surface 230 of a wall behind the television set. For example, a large television set or a video wall, comprising a wall for displaying a projected images or a set of displays, may be used to display video content. This surface 230 may vary in size and shape and is not limited to just a single wall but may be expanded to cover as much area within the room as desired. Furthermore, the surface 230 does not necessarily need to surround the television set, as illustrated, but may partially surround the television set or be located in various other positions on the wall or walls. As described above, the surround visual field may have various characteristics that relate it to the content displayed on the television screen 210. Various embodiments of the invention may be employed to project the surround visual field onto the surface of the wall or television set, two examples of which are described below.

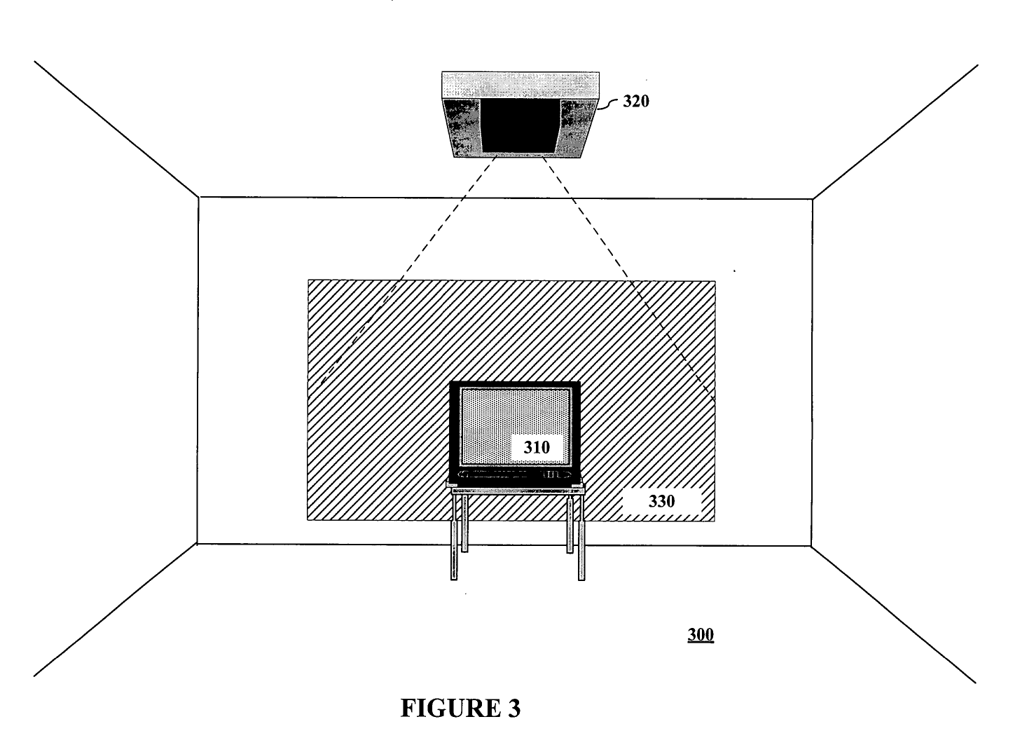

FIG. 3 illustrates one embodiment of the invention in which a surround visual field is projected directly onto an area 330 to supplement content displayed on a television screen 310 or other surface. Although illustrated as being shown on only one wall, the area 330 may extend to multiple walls depending on the type of projector 320 used or the room configuration. The projector 320 is integrated with or connected to a device (not shown) that controls the projected surround visual field. In one embodiment, this device may be provided the audio/video stream that is displayed on the television screen 310. In another embodiment, this device may contain data that was authored to project and synchronize the surround visual field to the content being displayed on the television screen 310. In various embodiments of the invention, the audio/video stream is analyzed, relative to one or more characteristic of the input stream, so that the surround visual field may be properly rendered and animated to synchronize to the content displayed on the television screen 310.

In yet another embodiment of the invention, a video display and surround visual field may be shown within the boundaries of a display device such as a television set, computer monitor, laptop computer, portable device, etc. In this particular embodiment, there may or may not be a projection device that extends the surround visual field beyond the boundaries of the display device. The surround visual field, shown within the boundaries of the display device, may have various shapes and contain various types of content including images, patterns, textures, text, varying color, or other content.

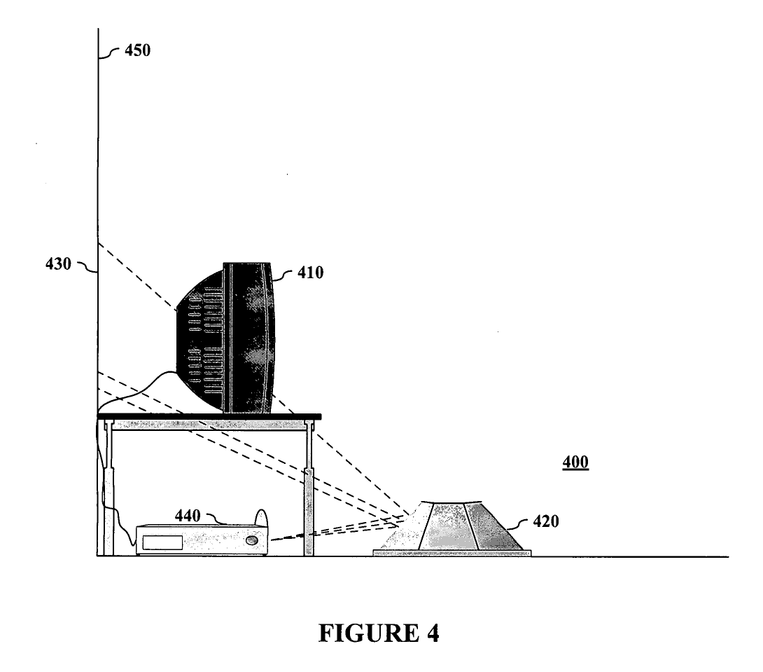

FIG. 4 illustrates a reflective system for providing surround visual fields according to another embodiment of the invention. The system 400 may include a single projector or multiple projectors 440 that are used to generate the surround visual field. In one embodiment of the invention, a plurality of light projectors 440 produces a visual field that is reflected off a mirrored pyramid 420 in order to effectively create a virtual projector. The plurality of light projectors 440 may be integrated within the same projector housing or in separate housings. The mirrored pyramid 420 may have multiple reflective surfaces that allow light to be reflected from the projector to a preferred area in which the surround visual field is to be displayed. The design of the mirrored pyramid 420 may vary depending on the desired area in which the visual field is to be displayed and the type and number of projectors used within the system. Additionally, other types of reflective devices may also be used within the system to reflect a visual field from a projector onto a desired surface. In another embodiment, a single projector may be used that uses one reflective surface of the mirror pyramid 420, effectively using a planar mirror. The single projector may also project onto multiple faces of the mirror pyramid 420, in which a plurality of virtual optical centers is created.

In one embodiment of the invention, the projector or projectors 440 project a surround visual field 430 that is reflected and projected onto a surface of the wall 450 behind the television 410. As described above, this surround visual field may comprise various images, shapes, patterns, textures, colors, etc. and may relate to content being displayed on the television 410 in various ways.

One skilled in the art will recognize that various reflective devices and configurations may be used within the system 400 to achieve varying results in the surround visual field. Furthermore, the projector 440 or projectors may be integrated within the television 410 or furniture holding the television 410. One skilled in the art will also recognize that one or more televisions may be utilized to display the input content and a surround field, including but not limited to, a single display or a set of displays, such as a set of tiled displays.

D. Applications of Surround Visual Fields

Although the above description has generally described the use of surround visual fields in relation to audio/visual presentation environments such as home television and projection systems, theatre systems, display devices, and portable display devices, the invention may be applied to numerous other types of environments. Furthermore, the systems used to generate and control the surround visual fields may have additional features that further supplement the basic implementations described above. Below are just a few such examples, and one skilled in the art will recognize that other applications, not described below, will also fall under the scope of the present invention.

### (i) Gaming Application

A surround visual field may be created and controlled relative to a characteristic(s) of a video game that is being played by an individual. For example, if a user is moving to the left, previously rendered screen content may be stitched and displayed to the right in the surround area. Other effects, such as shaking of a game controller, may be related to the surround visual field being displayed in order to enhance the experience of shaking. In one embodiment, the surround visual field is synthesized by processing a video stream of the game being played.

### (ii) Interactive Surround Visual Fields

A surround visual field may also be controlled interactively by a user viewing a video, listening to music, playing a video game, etc. In one embodiment, a user is able to control certain aspects of the surround visual field that are being displayed. In another embodiment, a surround visual field system is able to sense its environment and respond to events within the environment, such as responding to the location of a viewer within a room in which the system is operating.

Viewpoint compensation may also be provided in a surround visual field system. Oftentimes, a viewer is not located in the same position as the virtual center of projection of the surround visual field system. In such an instance, the surround visual field may appear distorted by the three dimensional shape of the room. For example, a uniform pattern may appear denser on one side and sparser on the other side to the viewer caused by mismatch between the projector's virtual center and the location of the viewer. However, if the viewer's location may be sensed, the system may compensate for the mismatch in its projection of the surround visual field. This location may be sensed using various techniques including the use of a sensor (e.g., an infrared LED) located on a television remote control to predict the location of the viewer. Other sensors, such as cameras, microphones, and other input devices, such as game controllers, keyboards, pointing devices, and the like may be used to allow a user to provide input cues.

### (iii) Sensor Enhanced Displays

Sensors that are positioned on components within the surround visual field system may be used to ensure that proper alignment and calibration between components are maintained, may allow the system to adapt to its particular environment, and/or may be used to provide input cues. For example, in the system illustrated in FIG. 3, it is important for the projector 320 to identify the portion of its projection field in which the television is located. This identification allows the projector 320 to (1) center is surround visual field (within the area 330) around the screen 310 of the television set; (2) prevent the projection, if so desired, of the surround visual field onto the television; and (3) assist in making sure that the surround visual field pattern mosaics seamlessly with the television set display.

In one embodiment, the sensors may be mounted separately from the projection or display optics. In another embodiment, the sensors may be designed to share at least one optical path for the projector or display, possibly using a beam splitter.

In yet another embodiment, certain types of media may incorporate one or more surround video tracks that may be displayed in the surround visual field display area. One potential form of such media may be embedded sprites or animated visual objects that can be introduced at opportune times within a surround visual field to create optical illusions or emphasis. For example, an explosion in a displayed video may be extended beyond the boundaries of the television set by having the explosive effects simulated within the surround visual field. In yet another example, a javelin that is thrown may be extended beyond the television screen and its path visualized within the surround visual field. These extensions within the surround visual field may be authored, such as by an individual or a content provider, and synchronized to the media content being displayed.

Other implementations, such as telepresence and augmented reality, may also be provided by the present invention. Telepresence creates the illusion that a viewer is transported to a different place using surround visual fields to show imagery captured from a place other than the room. For example, a pattern showing a panoramic view from a beach resort or tropical rainforest may be displayed on a wall. In addition, imagery captured by the visual sensors in various surround visual field system components may be used to produce imagery that mixes real and synthesized objects onto a wall.

E. Surround Visual Field Animation

As described above, the present invention allows the generation and control of a surround visual field in relation to audio/visual content that is being displayed. In one embodiment, the surround visual field may be colorized based on color sampled from a conventional video stream. For example, if a surround visual field system is showing a particular simulation while the video stream has a predominant color that is being displayed, the surround visual field may reflect this predominant color within its field. Elements within the surround visual field may be changed to the predominant color, the surround visual field itself may be changed to the predominant color, or other characteristics of the surround visual field may be used to supplement the color within the video stream. This colorization of the surround visual field may be used to enhance the lighting mood effects that are routinely used in conventional content, e.g., color-filtered sequences, lightning, etc.

In yet another embodiment, the surround visual field system may relate to the audio characteristics of the video stream, such as a Surround Sound audio component. For example, the surround visual field may respond to the intensity of an audio component of the video stream, pitch of the audio component or other audio characteristic. Accordingly, the surround visual field is not limited to relating to just visual content of a video stream, but also audio or other characteristics.

For exemplary purposes, an embodiment in which the motion within video content is used to define movement of elements within the surround visual field is described. One skilled in the art will recognize that various other characteristics of the audio/visual content may be used to generate or control the surround visual field. Furthermore, the cues or content for the surround visual field may be authored by an individual to relate and/or be synchronized to content being displayed.

F. Surround Visual Field Controller Relating to Motion

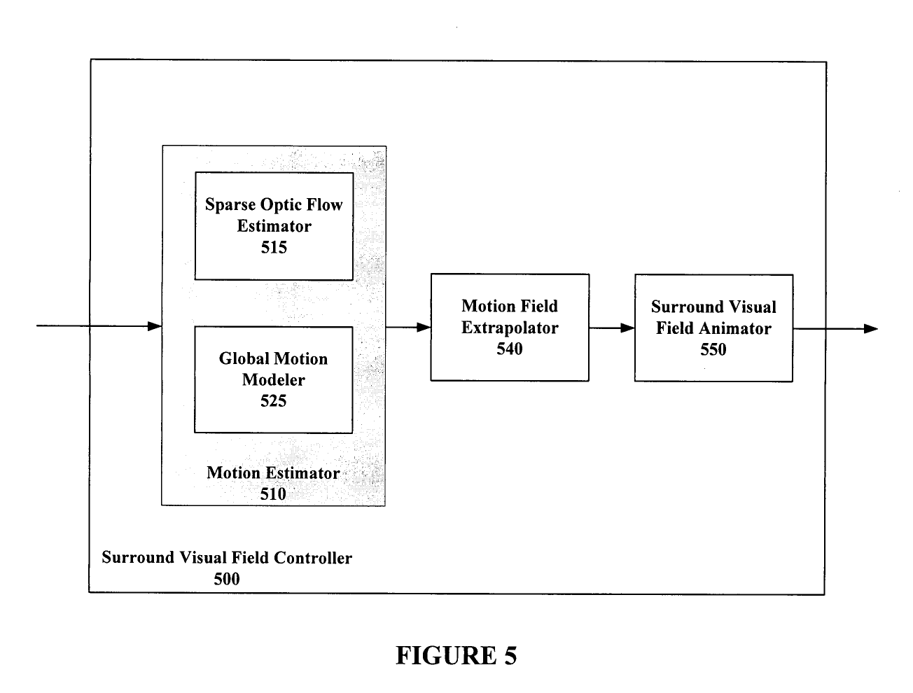

FIG. 5 illustrates an exemplary surround visual field controller 500 in which motion within video content is used to generate a surround visual field according to one embodiment of the invention. The controller 500 may be integrated within a projection device, connected to a projection device, or otherwise enabled to control surround visual fields that are projected and displayed in a viewing area. In one embodiment, the controller 500 is provided a video signal that is subsequently processed in order to generate and control at least one surround visual field in relation to one or more video signal characteristics, or cues/control signals. For example, the controller 500 may render and control a surround visual field that relates to the movement within video content that is being displayed.

In an embodiment, the controller 500 contains a motion estimator 510 that creates a model of global motion between successive video frame pairs, a motion field extrapolator 540 that extrapolates the global motion model beyond the boundaries of the video frame, and a surround visual field animator 550 that renders and controls the surround visual field, and elements therein, in relation to the extrapolated motion model. In one embodiment, the motion estimator 510 includes an optic flow estimator 515 to identify optic flow vectors between successive video frame pairs and a global motion modeler 525 that builds a global motion model using the identified optic flow vectors. Each component will be described in more detail below.

a) Motion Estimator

The motion estimator 510 analyzes motion between a video frame pair and creates a model from which motion between the frame pair may be estimated. The accuracy of the model may depend on a number of factors including the density of the optic flow vector field used to generate the model, the type of model used and the number of parameters within the model, and the amount and consistency of movement between the video frame pair. The embodiment below is described in relation to successive video frames; however, the present invention may estimate and extrapolate motion between any two or more frames within a video signal and use this extrapolated motion to control a surround visual field.

In one example, motion vectors that are encoded within a video signal may be extracted and used to identify motion trajectories between video frames. One skilled in the art will recognize that these motion vectors may be encoded and extracted from a video signal using various types of methods including those defined by various video encoding standards (e.g. MPEG, H.264, etc.). In another example that is described in more detail below, optic flow vectors may be identified that describe motion between video frames. Various other types of methods may also be used to identify motion within a video signal; all of which are intended to fall within the scope of the present invention.

b) Optic Flow Estimator

In one embodiment of the invention, the optic flow estimator 515 identifies a plurality of optic flow vectors between a pair of frames. The vectors may be defined at various motion granularities including pixel-to-pixel vectors and block-to-block vectors. These vectors may be used to create an optic flow vector field describing the motion between the frames.

The vectors may be identified using various techniques including correlation methods, extraction of encoded motion vectors, gradient-based detection methods of spatio-temporal movement, feature-based methods of motion detection and other methods that track motion between video frames.

Correlation methods of determining optical flow may include comparing portions of a first image with portions of a second image having similarity in brightness patterns. Correlation is typically used to assist in the matching of image features or to find image motion once features have been determined by alternative methods.

Motion vectors that were generated during the encoding of video frames may be used to determine optic flow. Typically, motion estimation procedures are performed during the encoding process to identify similar blocks of pixels and describe the movement of these blocks of pixels across multiple video frames. These blocks may be various sizes including a 16×16 macroblock, and sub-blocks therein. This motion information may be extracted and used to generate an optic flow vector field.

Gradient-based methods of determining optical flow may use spatio-temporal partial derivatives to estimate the image flow at each point in the image. For example, spatio-temporal derivatives of an image brightness function may be used to identify the changes in brightness or pixel intensity, which may partially determine the optic flow of the image. Using gradient-based approaches to identifying optic flow may result in the observed optic flow deviating from the actual image flow in areas other than where image gradients are strong (e.g., edges). However, this deviation may still be tolerable in developing a global motion model for video frame pairs.

Feature-based methods of determining optical flow focus on computing and analyzing the optic flow at a small number of well-defined image features, such as edges, within a frame. For example, a set of well-defined features may be mapped and motion identified between two successive video frames. Other methods are known which may map features through a series of frames and define a motion path of a feature through a larger number of successive video frames.

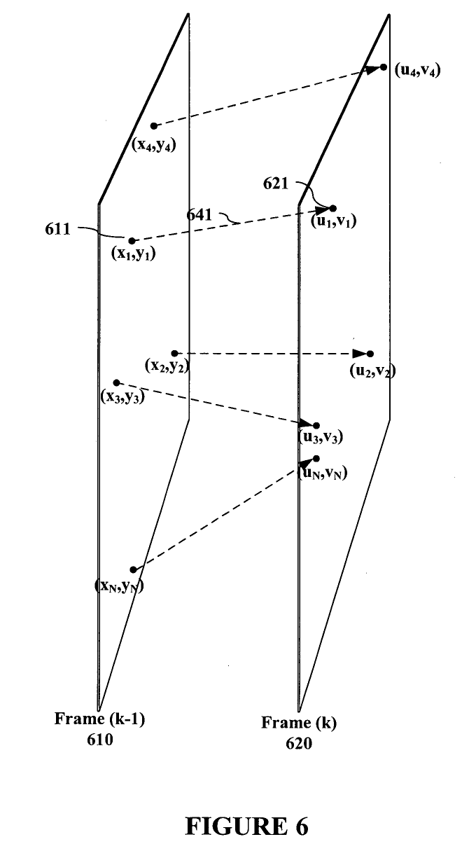

FIG. 6 illustrates exemplary optic flow vectors, at a pixel level, between successive video frames according to one embodiment of the invention. A first set of pixel points within a first frame, Frame (k-1) 610, are identified. This identification may be done based on motion identified within previous frames, motion vector information extracted from the encoding of the video frame 610, randomly generated, or otherwise identified so that a plurality of points are selected.

Vectors describing the two-dimensional movement of the pixel from its location in the first video frame 610 to its location in the second video frame 620 are identified. For example, the movement of a first pixel at location (x₁, y₁) 611 may identified to its location in the second frame (u₁, v₁) 621 by a motion vector 641. A field of optic flow vectors may include a variable number (N) of vectors that describe the motion of pixels between the first frame 610 and the second frame 620.

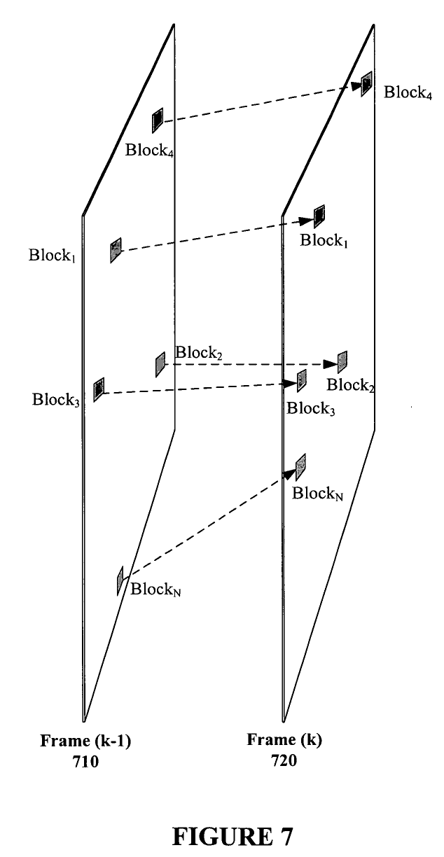

FIG. 7 illustrates successive video pair frames in which optic flow vectors between blocks are identified according to one embodiment of the invention. As mentioned above, optic flow vectors may also describe the movement of blocks of pixels, including macroblocks and sub-blocks therein, between a first frame, Frame (k-1) 710 and a second frame, Frame (k) 720. These vectors may be generated using the various techniques described above including being extracted from encoded video in which both motion and distortion between video blocks is provided so that the video may be reproduced on a display device. An optic flow vector field may then be generated using the extracted motion vectors. The optic flow vector field may also be generated by performing motion estimation wherein a block in the first frame 710 is identified in the second frame 720 by performing a search within the second frame for a similar block having the same or approximately the same pixel values. Once a block in each frame is identified, a motion vector describing the two-dimensional movement of the block may be generated.

c) Global Motion Modeler

The optic flow vector field may be used to generate a global model of motion occurring between a successive video frame pair. Using the identified optic flow vector field, the motion between the video frame pair may be modeled. Various models may be used to estimate the option flow between the video frame pair. Typically, the accuracy of the model depends on the number of parameters defined within the model and the characteristics of motion that they describe. For example, a three parameter model may describe displacement along two axes and an associated rotation angle. A four parameter model may describe displacement along two axes, a rotation angle and a scaling factor to describe motion within the frame.

In one embodiment of the invention, a six parameter model, called an “Affine Model,” is used to model motion within the video frame. This particular model describes a displacement vector, a rotation angle, two scaling factors along the two axes, and the scaling factors' orientation angles. In general, this model is a composition of rotations, translations, dilations, and shears describing motion between the video frame pair.

The global motion modeler 525 receives the optic flow vector field information and generates a six parameter Affine Model estimating the global motion between the video frame pairs. From this model, motion between the frame pair may be estimated according to the following two equations:
u=a₁+a₂x+a₃y (1)
v=a₄+a₅x+a₆y (2)

where a₁ . . . a₆ are parameters of the model.

In order to solve the six parameter, a₁ through a₆, a minimum of three optic flow vectors must have been previously defined. However, depending on the desired accuracy of the model, the optic flow vector field used to create the model may be denser in order to improve the robustness and accuracy of the model.

The global motion modeler 525 defines the model by optimizing the parameters relative to the provided optic flow vector field. For example, if N optic flow vectors and N corresponding pairs of points (x₁,y₁) . . . (x_{N}, y_{N}) and (u₁, v₁) . . . (u_{N}, v_{N}) are provided, then the parameters a₁ through a₆ may be solved according to an optimization calculation or procedure.

$$( \begin{matrix}{u}_{1} \\ ⋮ \\ {u}_{n} \\ {v}_{1} \\ ⋮ \\ {v}_{n}\end{matrix} ) = ( \begin{matrix}1 & {x}_{1} & {y}_{1} & 0 & 0 & 0 \\ & ⋮ & & & ⋮ & \\ 1 & {x}_{n} & {y}_{n} & 0 & 0 & 0 \\ 0 & 0 & 0 & 1 & {x}_{1} & {y}_{1} \\ & ⋮ & & & ⋮ & \\ 0 & 0 & 0 & 1 & {x}_{n} & {y}_{n}\end{matrix} ) ( \begin{matrix}{a}_{1} \\ {a}_{2} \\ {a}_{3} \\ {a}_{4} \\ {a}_{5} \\ {a}_{6}\end{matrix} ) \qquad ( 3 )$$

By optimizing the six parameters so that the smallest error between the model and the optic flow vector field is identified, a global motion model is generated. One method in which the parameters may be optimized is by least squared error fitting to each of the vectors in the optic flow vector field. The parameter values providing the lowest squared error between the optic flow vector field and corresponding modeled vectors are selected.

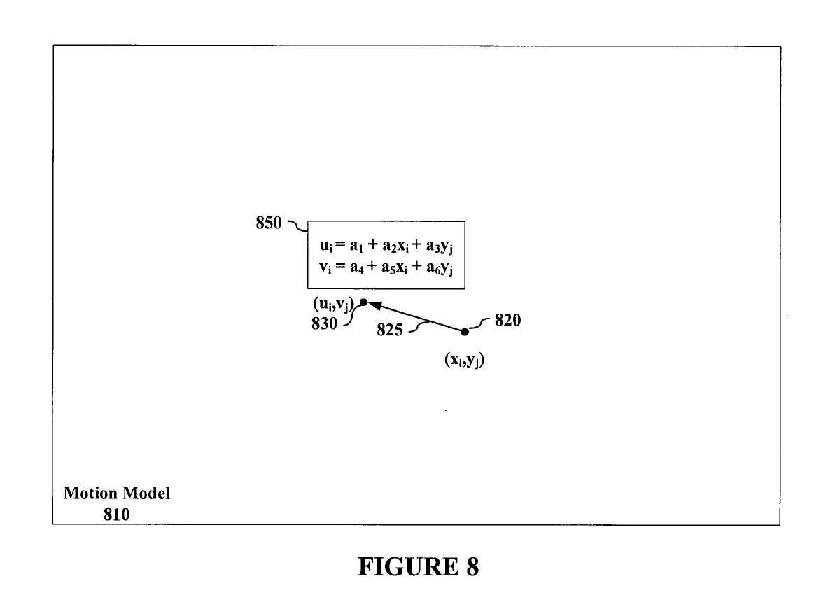

FIG. 8 illustrates an example of how a motion vector, within the global motion model 810, may be generated according to one embodiment of the invention. In this example, the motion relative to (xᵢ, yⱼ) 820 is identified by solving the equations 850 of the Affine Model to calculate (uᵢ, vⱼ) 830. From these two points, a motion vector 825 may be calculated and used to grow the global motion model 810.

The described used of an Affine Model to generate the global motion model is not intended to exclude other types of models. For example, an eight parameter model that also describes three-dimensional rotation may also be used and may more accurately describe the motion within the video frame. However, the added parameters will require additional computations to construct and extrapolate the model. Accordingly, one skilled in the art will recognize that various models may be used depending on the desired accuracy of the global motion model and computational resources available to the system.

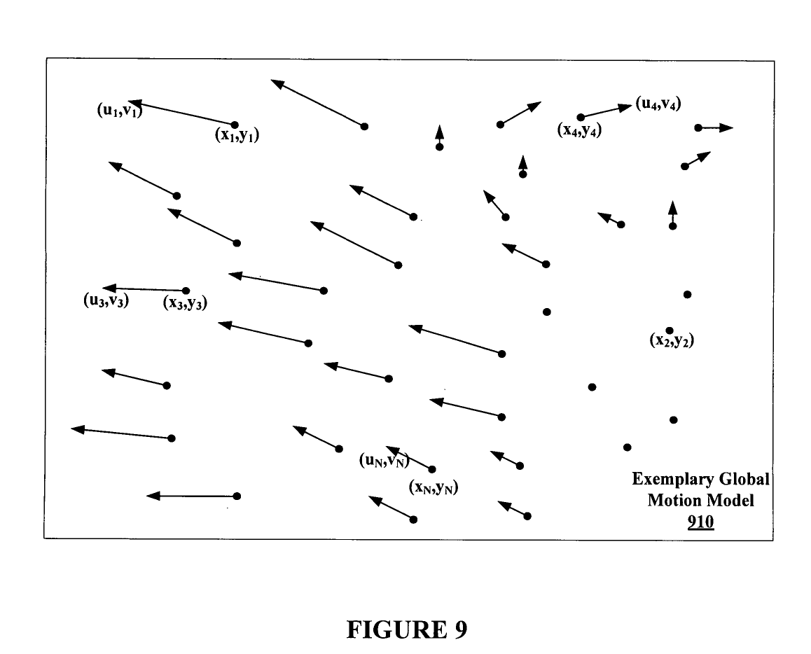

FIG. 9 illustrates an exemplary global motion model 910 between a video frame pair according to one embodiment of the invention. The illustration shows a plurality of motion vectors within the model, including four vectors estimating the movement associated with the four optic flow vectors shown in previous figures.

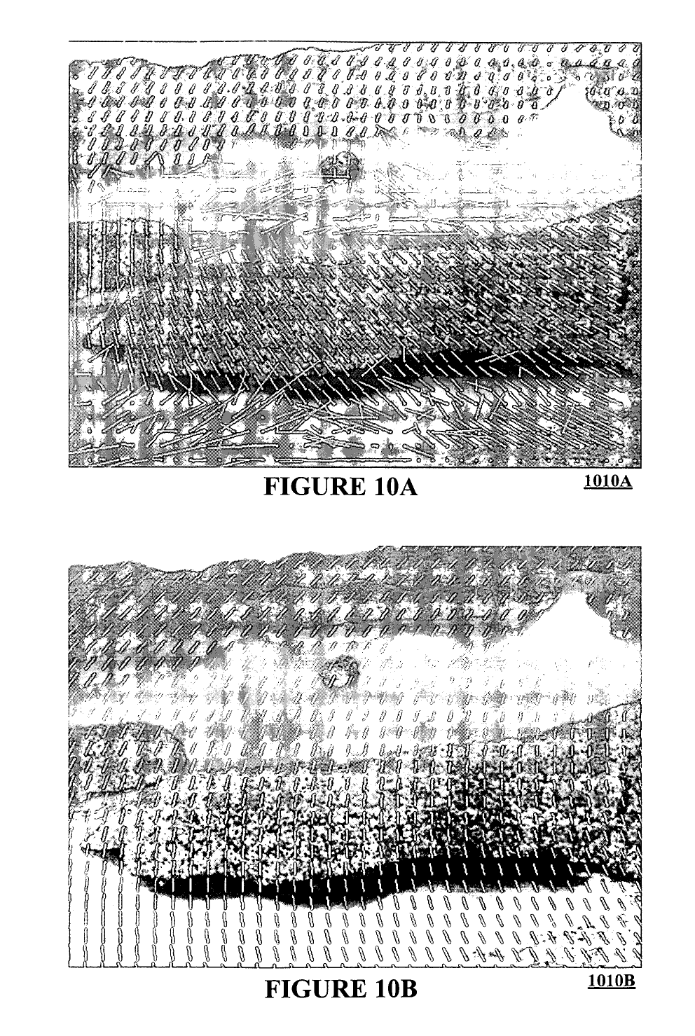

FIG. 10A shows a representative optic flow vector field 1010A overlaid on a video frame and FIG. 10B shows a global motion model 1010B, generated from the representative vector field, overlaid on the same video frame. Upon review, one skilled in the art will recognize that the global motion model may be used to extrapolate modeled motion within the video frame beyond the video frame boundaries.

d) Motion Field Extrapolator

The motion field extrapolator 540 extends the global motion model beyond the boundaries of the video frame to allow elements within the surround visual field beyond these frame boundaries to respond to motion within the frame. In one embodiment of the invention, the Affine Model equations defining motion vectors at (x_{N}, y_{N}) to (u_{N}, v_{N}) are used to expand the estimated motion beyond the boundaries of the frame, in which (x_{N}, y_{N}) are located beyond the boundaries of the video frame.

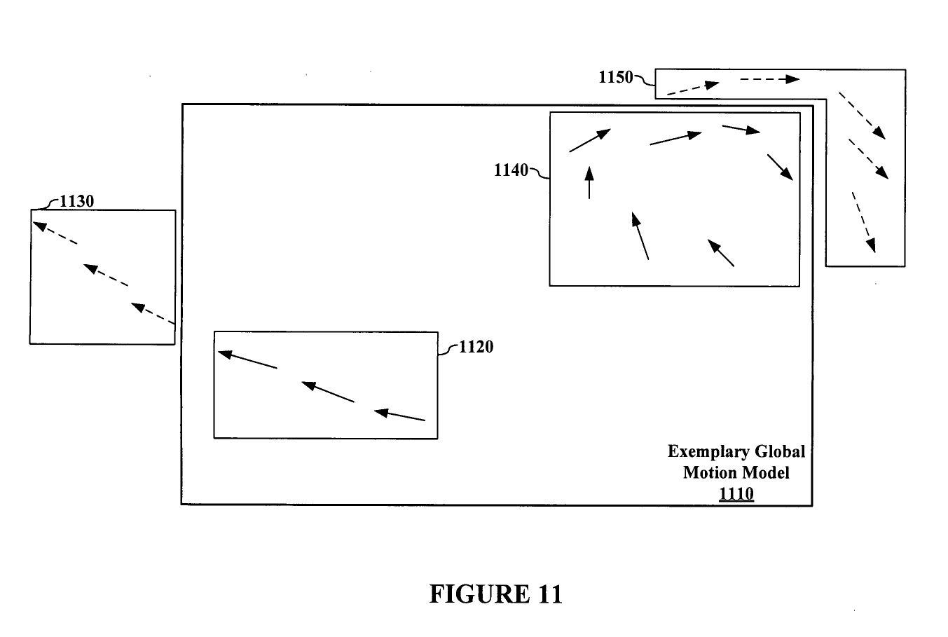

FIG. 11 illustrates exemplary motion extrapolation that may be performed according to one embodiment of the invention. A first set of motion vectors 1120 having motion that is moving up at a slight angle and towards the left boundary is shown. This motion may be extrapolated beyond the boundaries of the frame by using the global motion model. Accordingly, a second set of motion vectors 1130 beyond the video frame boundaries may be generated. In another example, a third set of motion vectors 1140 having a clockwise rotation is shown. This rotational motion may also be extrapolated beyond the video frame by using the global motion model resulting in a fourth set of motion vectors 1150 outside of the frame boundaries being generated.

These motion vectors (e.g., 1130, 1150) may be used to define the movement of the surround visual field, and/or element therein, that is projected around the display of the video frame. As the motion within the frame changes, the global motion model will respond resulting in the surround visual field changing. In one embodiment of the invention, the elements within the surround visual field subsequently respond and are controlled by the motion vectors that were extrapolated using the global motion model.

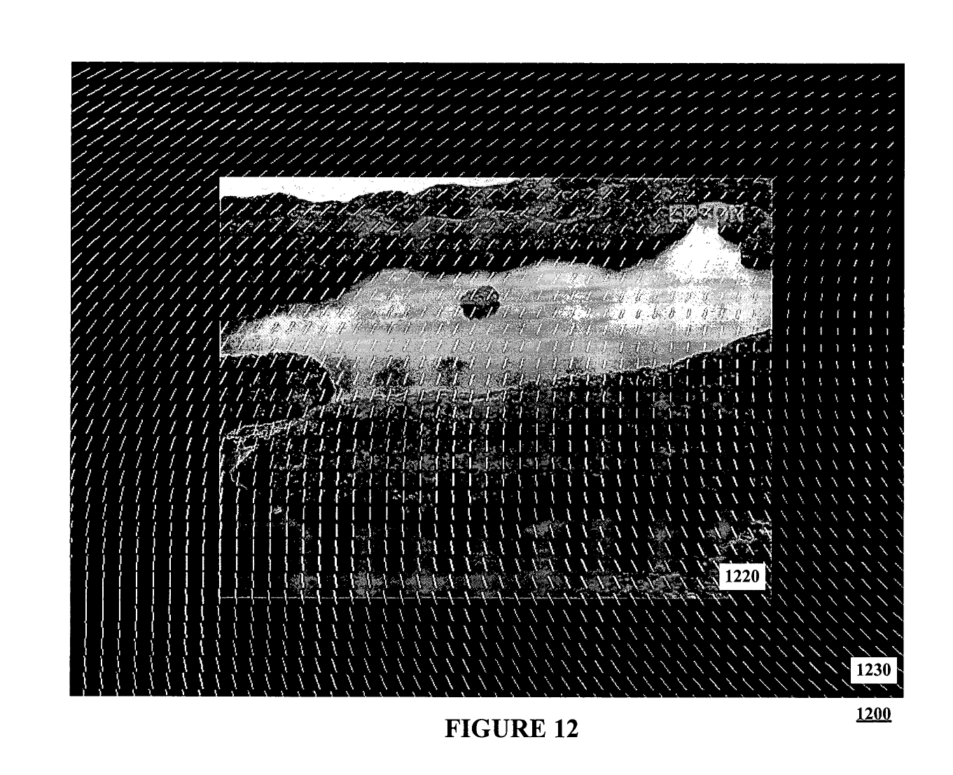

FIG. 12 illustrates an exemplary extrapolated global motion model that may be used to control the movement of a surround visual field, and elements therein, around a displayed video frame according to one embodiment of the invention. The vectors defined by the global motion model 1220 within the frame are shown and estimate the movement within the frame itself. This model is expanded beyond the boundaries of the frame to provide an extrapolated global motion model 1230. The vectors within the extrapolated global motion model 1230 may control the movement of elements within the surround visual field.

The surround visual field may also be projected onto a device displaying the video frame. In such an instance, the movement of the elements within the surround visual field on the device is controlled by the vectors within global motion model 1220 that estimate movement in the video frame.

e) Surround Visual Field Animator

The surround visual field animator 550 creates, animates and maintains the projected surround visual field according to at least one characteristic of the video content. In one embodiment, as described above, the elements within the surround visual field move in relation to motion within the video being displayed.

The surround visual field may be generated and maintained using various techniques. In one embodiment of the invention, elements within the surround visual field are randomly generated within the field and fade out over time. Additional elements are randomly inserted into the surround visual field to replace the elements that have faded out. These additional elements will also decay and fade out over time. The decay of elements and random replacement of elements within the surround visual field reduces the bunching or grouping of the elements within the surround visual field which may be caused by their movement over time.

### (i) Surround Visual Field Element Shapes

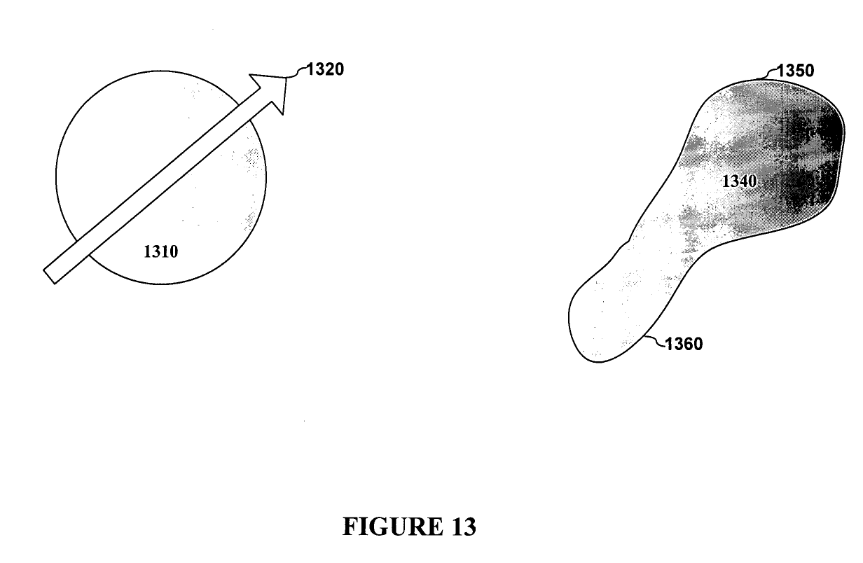

In addition to the movement, other characteristics of the surround visual field, including elements therein, may be controlled by an extrapolated global motion model. For example, the shape of each of the elements within the field may be determined by vectors within the global motion model. FIG. 13 illustrates one method in which the shape of an element relates to a corresponding motion vector.

In one embodiment of the invention, the shape of an element 1310 is affected by a motion vector 1320 corresponding to the location of the element 1310 relative to the global motion model. For example, the element 1310 may be expanded along an axis of a corresponding motion vector 1320 and weighting provided in the direction of the motion vector 1320. In the example illustrated in FIG. 13, the re-shaped element 1340 is stretched along a motion axis resulting in a narrower tail 1360 and a wider head 1350 pointing toward the direction of the motion vector 1320.

Other characteristics of the re-shaped element 1340 may also be modified to reflect the motion vector 1320. For example, the intensity at the head of the re-shaped element 1340 may be bright and then taper as it approaches the tail 1360 of the element 1340. This tapering of intensity relative to motion may enhance the perceived motion blur of the element as it moves within the surround visual field.

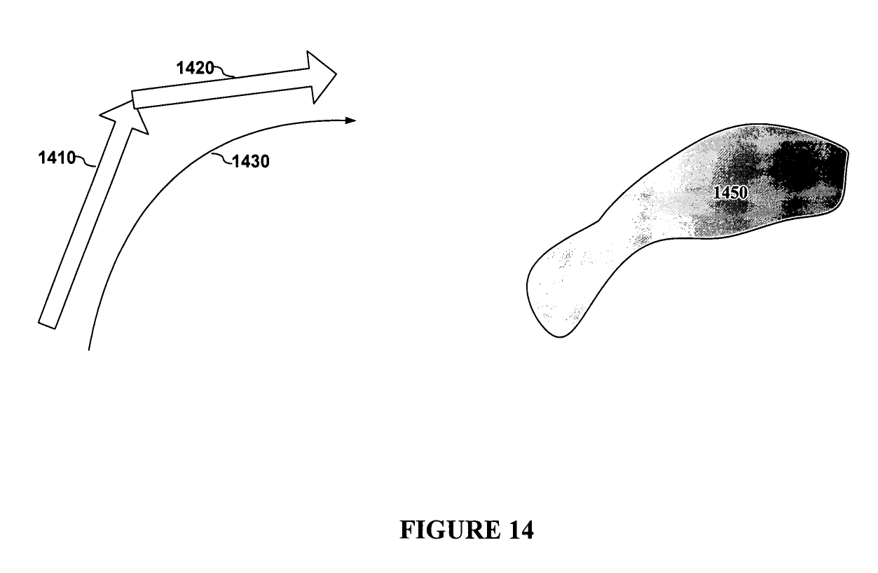

In yet another embodiment, the shape of an element may correspond to motion of sequential motion vectors relating to the element itself. FIG. 14 illustrates one method in which the element's shape and movement may be defined according to multiple motion vectors within the global motion model that occur over time. In this embodiment, an element moves relative to two sequential motion vectors 1410, 1420 that were modeled from two video frame pairs. The path defined by the two vectors 1410, 1420 contains a sharp turn at the end of the first vector 1410 and the beginning of the second vector 1420. This turn may diminish the viewing quality of the motion of an element following the path and may appear to cause the element to jerk in its motion.

The path may be smoothed into a curved path 1430 that does not contain any sudden motion changes. This smoothing may be performed by various mathematical equations and models. For example, a re-shaped element 1450 may reflect the curved path in which the element 1450 is elongated along the curve 1430. The intensity of the re-shaped element 1450 may vary to further enhance the motion appearance by having the intensity be the brightest near the head of the point and gradually tapering the brightness approaching the tail.

One skilled in the art will recognize that there are other methods in which the shape of an element may be modified to accentuate the motion of the surround visual field.

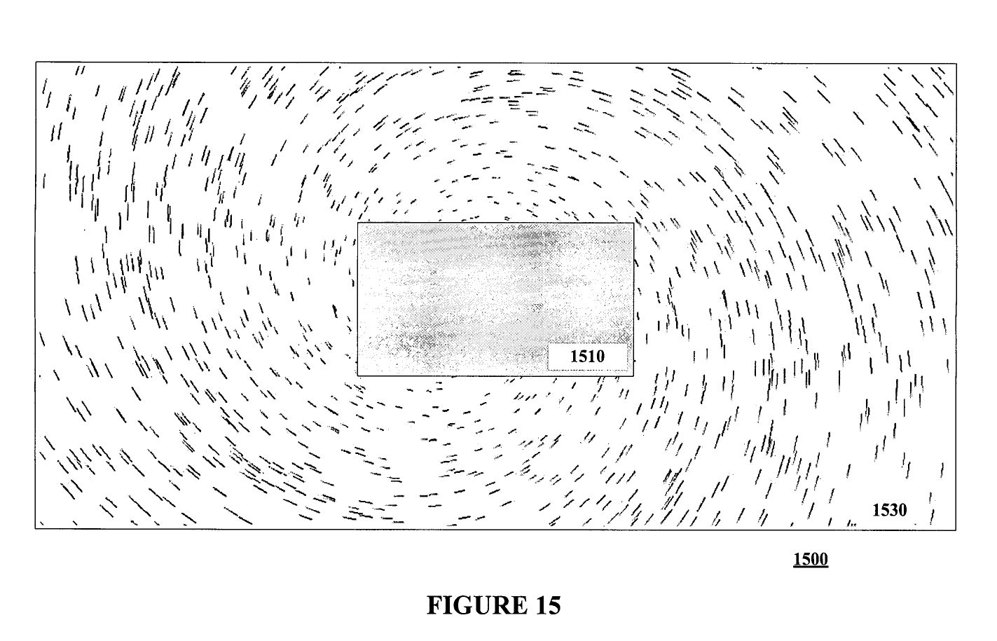

FIG. 15 is an illustrative example of a video presentation including surround visual field according to one embodiment of the invention. In this example, video is being shown a screen 1510 in which counter-clockwise motion is dominant in the frame. This dominant motion is modeled, extrapolated and used to animate a surround visual field 1530. In this particular example, the surround visual field 1530 also is rotating in a counter-clockwise manner; thereby enhancing the motion within the screen 1510. This surround visual field greatly expands the area in which motion is displayed to an individual and may increase the immersive effects of the video itself.

G. Creating Three-dimensional Surround Environments

In embodiments, various techniques may be employed to create an interactive and immersive three-dimensional (3D) environment that enhances the field of view of a traditional display. For example, three-dimensional environments of natural phenomena, such as, for example, terrain, ocean, and the like, may be synthesized and a two-dimensional representation displayed as the surround video field. As noted previously, embodiments of the present invention can improve the immersion of entertainment systems by creating a surround field presentation using one or more cues or control signals related to the input stream. In embodiments, three-dimensional environments may be interactive, wherein elements within the environment change in response to variations in the input stream, such as, for example, scene lighting, camera motion, audio, and the like.

In embodiments, interactivity may be achieved using physical simulations, wherein one or more of the dynamics or elements of the surround scene are controlled by one or more cues or control signals related to the input stream. In an embodiment, to render these three-dimensional surround simulations in real-time, one or more image-based rendering algorithms may be employed using data from input stream. In an embodiment, the surround field may be generated from pre-computed data, including without limitation, image-based rendering and authored cues and/or authored content.

1. Surround Field Controller

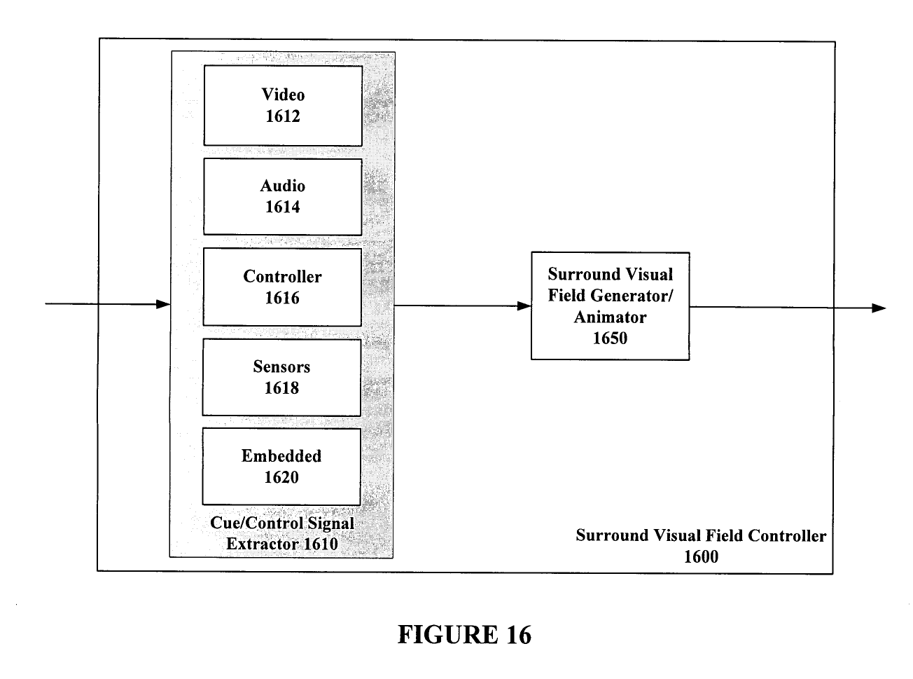

FIG. 16 illustrates an exemplary surround field controller 1600 in which cues or control signals may be extracted from an input stream or are received from other sources and used to generate a surround field according to one embodiment of the invention. The controller 1600 may be integrated within a display device (which shall be construed to include a projection device), connected to a display device, or otherwise enabled to control surround visual fields that are displayed in a viewing area. Controller 1600 may be implemented in software, hardware, firmware, or a combination thereof. In an embodiment, the controller 1600 receives one or more input signals that may be subsequently processed in order to generate and/or control at least one surround visual field.

As depicted in FIG. 16, the controller 1600 includes a control signal, or cue, extractor 1610, which may comprise a plurality of extractors 1612-1620 to extract or derive control signals from a variety of sources, including from the input audio/video stream, an input devices (such as a game controller), one or more sensors (such as a location sensor included with a remote control), and from embedded or authored control signals or authored content. For example, the controller 1600 may render and control a surround visual field that relates to the movement within the content that is being displayed. In an embodiment, control signal extractor 1610 may obtain motion cues or control signals from the video as described previously. In an embodiment, control signal extractor 1610 may use audio signals, such as phase differences between audio channels, volume levels, audio frequency analysis, and the like to obtain control signals from the audio signals. In an embodiment, a content provider may embed control signals in the input video stream or include control signals on a data channel.

In an embodiment, the control signal extractor 1610 may be coupled to a surround visual field generator/animator 1650. It shall be noted that the terms “coupled” or “communicatively coupled,” whether used in connection with modules, devices, or systems, shall be understood to include direct connections, indirect connections through one or more intermediary devices, and wireless connections. The extracted controls signals are supplied to the surround field generator or animator 1650, which uses the control signals to create or synthesize the surround field. The surround field generator 1650 may be configured into one or more sub-components or modules, such as, for example, as described with respect to FIG. 5. In embodiments, the surround field generator 1650 may use physics-based modeling and the control signals to generate a three-dimensional environment to have elements in the surround field react in a realistic manner. Embodiments of the surround field generator 1650 may use pre-computed data, such as images-based techniques and/or authored content to generate surround field. In embodiments, the surround field generator 1650 may generate non-realistic effects or additional effects, such as motion extension or highlighting, scene extensions, color extension or highlighting, and the like.

Surround field generator or animator 1650 may use more than one control signal in the creating the surround field. In embodiments, generator 1650 may use multiple control signals to animate elements in the surround field so that it is consistent with the content creator's design. The generator 1650 may also use or compare control signals to simplify decisions for resolving conflicting control signals.

In embodiments, controller 1600 may animate a surround field based on surround field information provided by a content provider. For example, the provider of a video game or movie may author or include surround field information with the input stream. In an embodiment, the surround field may be fully authored. In alternative embodiments, the surround field may be partially authored. In embodiments, one or more control signals may be provided and a surround field generated related to the provided control signals.

It shall be noted that no particular configuration of controller 1600 is critical to the present invention. One skilled in the art will recognize that other configurations and functionality may be excluded from or included within the controller and such configurations are within the scope of the invention.

2. Deriving Animation Control Signals from Images and Video

As previously discussed, the elements displayed in the surround video may be animated based on control signals or cues extracted from the input stream. In an embodiment, control signals from the input stream may be obtained from one or more sources, including without limitation, the video frames (such as color and motion), audio channels, a game controller, viewer location obtained from input sensors, remote controls, and input from other sensors. In embodiments, an animation control signal or signals may be computed that are driven by or related to one or more of the cues.

a) Light Sources

In an embodiment, the input control signals may be used to control the position, intensity, and/or color of single or multiple light sources in the three-dimensional surround environment. For example, when the source video shows a bright object, for example, a light, the moon, the sun, a car headlamp, and the like) moving in a direction, such as moving from left to right, a virtual light source with the same color as that of the bright object can also move in the same direction in the 3D surround environment, inducing changes in the scene appearance due to surface shading differences and moving shadows. The virtual light source in the scene may also vary its intensity based on the overall brightness of the video frame.

b) Wind Fields

In another illustrative example, motion in the source video stream may also be used to induce a wind field in the 3D surround environment. For example, when objects move across the video, a wind field may be induced in the virtual three-dimensional surround field that moves elements in the scene in the same direction. That is, for example, elements in the scene, such as trees, may move or sway in relation to the wind field.

c) Disturbances

In an embodiment, events detected from one or more of the input cues may also be used to introduce disturbances in the three-dimensional surround environment. In embodiments, when a video transitions from a period of little or no motion to a scene with lots of motion, a “disturbance” event may be introduced so that elements in the surround scene can react to the event.

Consider, by way of illustration, a surround scene with fish swimming. If an input cue or cues indicate a disturbance event, such as a dramatic increase in audio volume, and/or rapid motion in the video, the fish may dart and swim at a higher velocity when the disturbance is introduced. In an embodiment, the fish may also be made to swim away from a perceived epicenter of the disturbance.

3. Synthesizing Three-Dimensional Surround Fields

An aspect of the present invention is the synthesizing of three-dimensional environments which may than be displayed as surround fields. In embodiments, physics-based simulation and rendering techniques know to those skilled in the art of computer animation may be used to synthesize the surround field. In an embodiment, photo-realistic backgrounds of natural phenomena such as mountains, forests, waves, clouds, and the like may be synthesized. In embodiments, other backgrounds or environments may be depicted and react, at least in part, according to one or more control signals. To generate interactive content to display in the surround field, the parameters of two-dimensional and/or three-dimensional simulations may be coupled to or provided with control signals extracted from the input stream.

For purposes of illustration, consider the following embodiments of 3D simulations in which dynamics are approximated by a Perlin noise function. Perlin noise functions have been widely used in computer graphics for modeling terrain, textures, and water, as discussed by Ken Perlin in “An image synthesizer,” Computer Graphics (Proceedings of SIGGRAPH 1985), Vol. 19, pages 287-296, July 1985; by Claes Johanson in “Real-time water rendering,” Master of Science Thesis, Lund University, March 2004; and by Ken Perlin and Eric M. Hoffert in “Hypertexture,” Computer Graphics (Proceedings of SIGGRAPH 1989), Vol. 23, pages 253-262, July 1989, each of which is incorporated herein by reference in its entirety. It shall be noted that the techniques presented herein may be extended to other classes of 3D simulations, including without limitation, physics-based systems.

A one-dimensional Perlin function is obtained by summing up several noise generators Noise(x) at different amplitudes and frequencies:

$$N ( x ) = β {\sum }_{i = 1}^{octaves} {α}^{i} Noise ( {2}^{i} x ) \qquad ( 4 )$$

The function Noise(x) is a seeded random number generator, which takes an integer as the input parameter and returns a random number based on the input. The number of noise generators may be controlled by the parameter octaves, and frequency at each level is incremented by a factor of two. The parameter α controls the amplitude at each level, and β controls the overall scaling. A two-dimensional version of Equation (4) may be used for simulating a natural looking terrain. A three-dimensional version of Equation (4) may be used to create water simulations.

The parameters of a real-time water simulation may be driven using an input video stream to synthesize a responsive three-dimensional surround field. The camera motion, the light sources, and the dynamics of the three-dimensional water simulation may be coupled to motion vectors, colors, and audio signals sampled from the video.

In an embodiment, the motion of a virtual camera may be governed by dominant motions from the input video stream. To create a responsive “fly-through” of the three-dimensional simulation, an affine motion model, such as discussed previously, may be fit to motion vectors from the video stream. An affine motion field may be decomposed into the pan, tilt, and zoom components about the image center (cₓ, c_{y}). These three components may be used to control the direction of a camera motion in simulation.

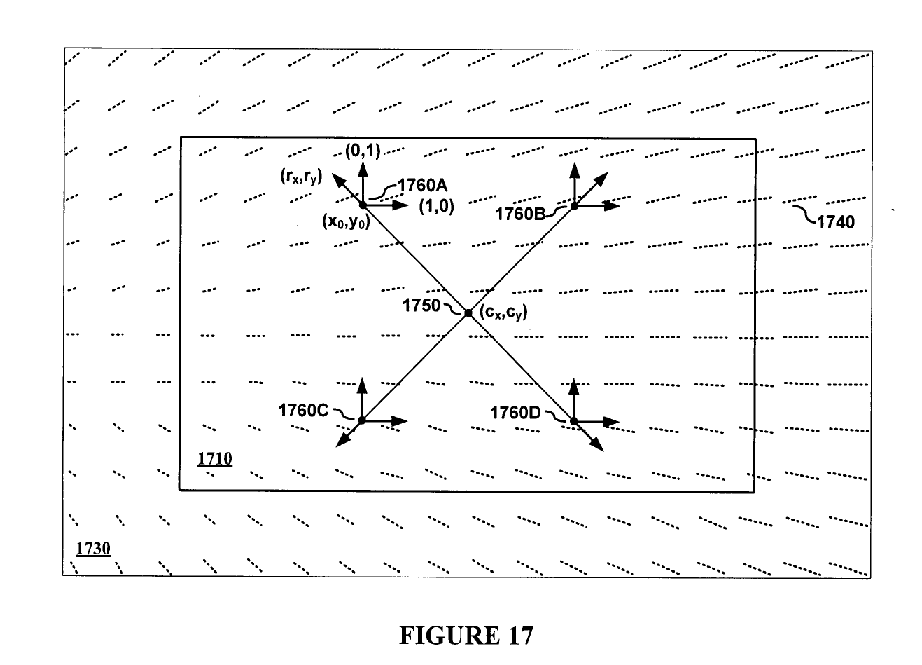

FIG. 17 depicts an input video stream 1710 and motion vectors field 1740, wherein the pan-tilt-zoom components may be computed from the motion vector field. In an embodiment, the pan-tilt-zoom components may be obtained by computing the projections of the motion vectors at four points 1760A-1760D equidistant from a center 1750. The four points 1760A-1760D and the directions of the projections are depicted in FIG. 17.

The pan component may be obtained by summing the horizontal components of the velocity vector (uᵢ, vᵢ) at four symmetric points (xᵢ, yᵢ) 1760A-1760D around the image center 1750:

$${V}_{pan} = {\sum }_{i = 1}^{4} ( {u}_{i} , {v}_{i} ) \cdot ( 1 , 0 ) \qquad ( 5 )$$

The tilt component may be obtained by summing the vertical components of the velocity vector at the same four points:

$${V}_{tilt} = {\sum }_{i = 1}^{4} ( {u}_{i} , {v}_{i} ) \cdot ( 0 , 1 ) \qquad ( 6 )$$

The zoom component may be obtained by summing the projections of the velocity vectors along the radial direction (rᵢ^{x},rᵢ^{y}):

$${V}_{zoom} = {\sum }_{i = 1}^{4} ( {u}_{i} , {v}_{i} ) \cdot ( {r}_{i}^{x} , {r}_{i}^{y} ) \qquad ( 7 )$$

In embodiment, control signals may be used to control light sources in the three-dimensional synthesis. A three-dimensional simulation typically has several rendering parameters that control the final colors of the rendered output. The coloring in a synthesized environment may be controlled or affected by one or more color values extracted from the input stream. In an embodiment, a three-dimensional environment may be controlled or affected by a three-dimensional light source C_{light}, the overall brightness C_{avg}, and the ambient color C_{amb}. In one embodiment, for each frame in the video, the average intensity, the brightest color, and the median color may be computed and these values assigned to C_{avg}, C_{ligh}, and C_{amb} respectively. One skilled in the art will recognize that other color values or frequency of color sampling may be employed.

In an embodiment, the dynamics of a simulation may be controlled by the parameters α and β in Equation (4). By way of illustration, in a water simulation, the parameter α controls the amount of ripples in the water, whereas the parameter β controls the overall wave size. In an embodiment, these two simulation parameters may be coupled to the audio amplitude Aₐₘₚ and motion amplitude Mₐₘₚ as follows:

$$\begin{matrix}\dot{α} = f ( {A}_{amp} ) & ( 8 ) \\ \dot{β} = ( 1 - \frac{α}{2} ) g ( {M}_{amp} ) & ( 9 )\end{matrix}$$

where Mₐₘₚ=Vₚₐₙ+Vₜᵢₗₜ+V_{zoom}; f(.) and g(.) are linear functions that vary the parameters between their acceptable intervals (αₘᵢₙ, αₘₐₓ) and (βₘᵢₙ, βₘₐₓ). The above equations result in the simulation responding to both the audio and motion events in the input video stream.

Those skilled in the art of simulation and rendering techniques, including without limitation, computer animation, will recognize other implementations may be embodiment to generate surround fields and such implementations fall within the scope of the present invention.

a) Static Scenes

One skilled in the art will recognize that any static scene, such as from nature, rural, urban, interior, exterior, surreal, fantasy, and the like may be used in the surround field. Three-dimensional models of scenes, such as forests, sky, desert, etc., are well suited for the surround video of static scenes whose illumination may be controlled by light sources from the input stream.

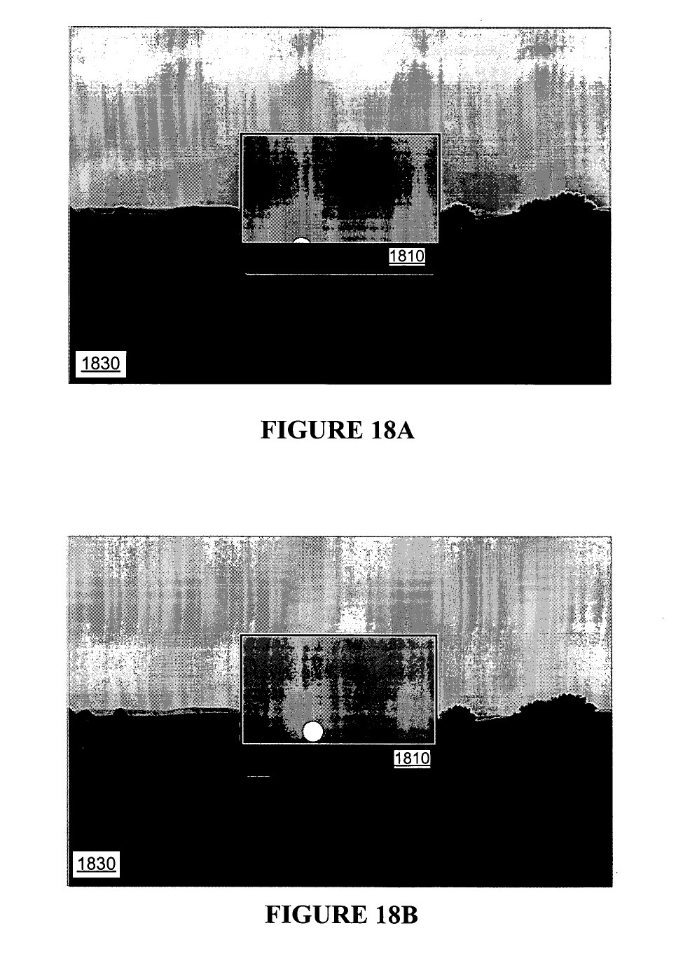

Consider, for example, the three-dimensional surround background 1830 depicted in FIG. 18. In the depicted example, the surround field 1830 is a background scene of terrain whose lighting is related to the light source in the input video stream 1810. Cues related to the input video 1810, such as position, intensity, and color of the lighting source (in this case the sun), may be used to model in a three-dimensional environment the lighting for the surround field 1830. As the sun rises through the different video frames, the surround field 1830 may change color and lighting, including shading and shadows, in response to a three-dimensional modeling of the sun rising in the input stream 1810. As depicted in FIGS. 18A and 18B, as the lighting condition in the input stream changes, those changes are modeled in a three-dimensional environment and the surround field terrain responds to that changing condition.

b) Dynamic Scenes

As noted previously, generating a surround video that moves in response to the input video can create a compelling sense of immersion. In embodiments, to achieve this effect, portions of the background may be simulated numerically or animated using laws of physics. Mathematic equations or models may be used to improve the realistic appearance of the surround field. In embodiments, by setting initial conditions, boundary conditions, and using physics-based animations, control signals related to the input stream may be applied to the model and may be used to generate the interaction of the elements within the surround field. The physic-based animations may including numerical simulations or apply known mathematical relationships, such as the laws of motion, fluid dynamics, and the like. Such methods and other methods are known to those skilled in the art of computer animation and are within the scope of the present invention.

Using physics-based modeling, the surround simulation may be driven by using control signals derived from the input stream to obtain realistic surround field interactions. For example, the motion vectors from the input video may be used to create an external wind field that affects the state of the simulation in the surround field. In another illustrative example, a sudden sound in the audio track may be used to create a ripple in a water simulation, or may cause elements in the surround field to move in response to the audio cue.

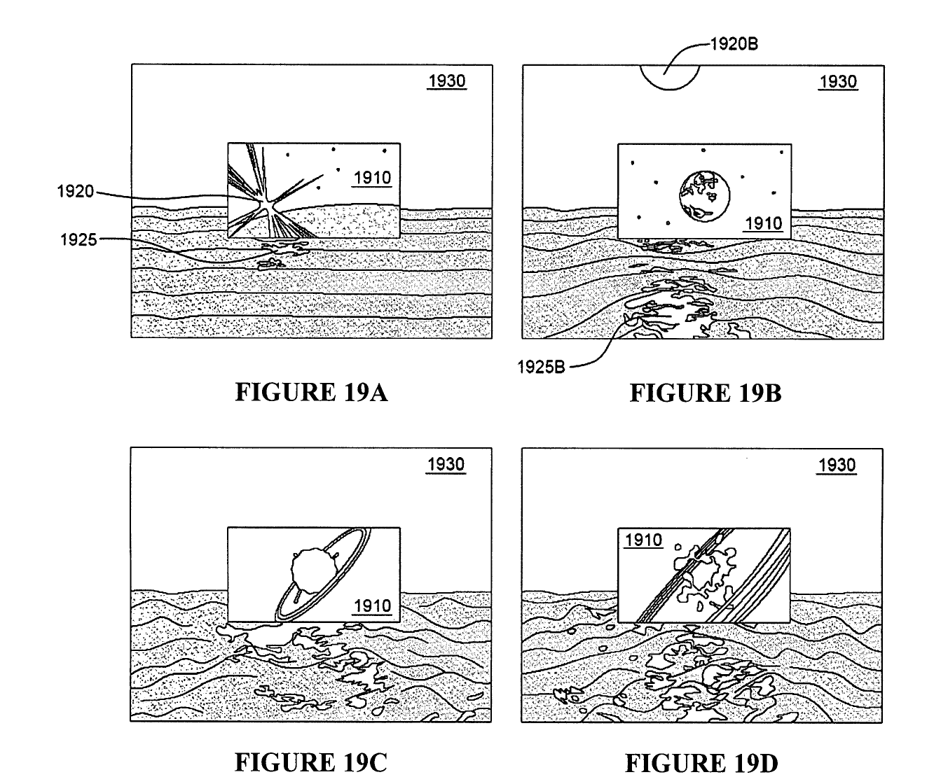

Consider, for example, the images depicted in FIGS. 19A-19D. The input stream 1910 contains a light source 1920. Control signals extracted from the stream, such as the position, intensity, and color of light source 1920, may be used to light the three-dimensional surround field elements. For example, note the light 1925 reflecting on the surface of the water, which represents the effect if the light source 1920 existed within the three-dimensional surround environment.

It should be noted that modeling the surround field may also include providing continuity between the input stream 1910 and the surround field 1930. For example, as depicted in FIG. 19B, as light source 1920 moves out of frame from the input stream 1910, the light source 1920B may become an element within the surround field 1930 and continue to move within the surround field along the same motion path it was traveling while in the input video 1910.

In the depicted embodiment, a sudden explosive event occurring in FIG. 19C illustrates how the surround field may be modeled to react. The colors of both the background and the water may change to relate to the color or colors in the explosion shown in the video stream 1910. Also, the water's surface has been disturbed related to the explosive event depicted in FIG. 19C. It should be noted that one cue, such as the explosion, may affect more than one mode in the surround field, in this case, both the color and the motion of the water. The realistic motion of the water may be determined by cues from the input stream, such as the intensity and location of the explosion, and from physics-based animations, including without limitation, those methods disclosed by Nick Foster and Ronald Fedkiw in “Practical Animation of Liquids,” Proceedings of ACM SIGGRAPH 2001, Computer Graphics Proceedings, Annual Conference Series, pages 23-30, August 2001, which is incorporated herein in its entirety. FIG. 19D further shows the surround field changing color and the water calming as the explosion in the input stream subsides.

c) Rendering the Surround

Rendering a high resolution surround video field in real-time may be very computationally intensive. In embodiments, a hybrid rendering system may be used to reduce the amount of computation. In an embodiment, a hybrid rendering approach may use image-based techniques for static portions of the scene and light transport-based techniques for the dynamic portions of the scene. Image-based techniques typically use pre-computed data, such as from reference images, and are therefore very fast for processing. In an embodiment, the amount of computation required may be reduced by using authored content or images, such as real sequences of natural phenomena.

d) Non-photorealistic surround.

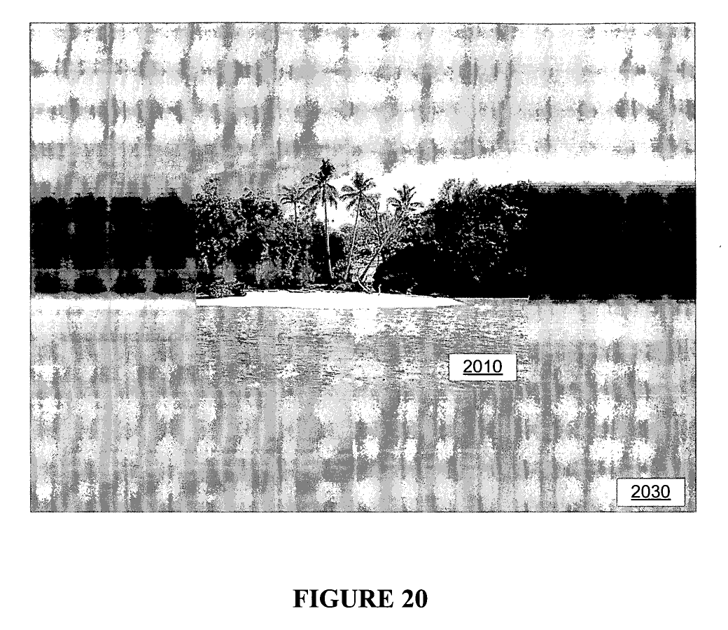

It should be noted that in addition to modeling realistic three-dimensional surround fields, other surround fields may also be depicted, including without limitation non-photorealistic surround fields. In an embodiment, non-photorealistic surround backgrounds may be synthesized directly from the control signals derived from the input stream. For example, the colors from the input picture 2010 shown in FIG. 20 may be used to synthesize the surround background 2030. In this example, the background color at each row is obtained by computing the median colors along the input picture 2010. One skilled in the art will recognize that a variety of non-realistic/non-photorealistic surround fields may be displayed, including without limitation, adding visual effects such as action lines, highlighting motions or colors, creating cartoon-like environments, and the like. It should also be noted, as illustrated by FIG. 20, that the input stream shall be construed to include images, as well as video data.

Those skilled in the art will recognize that various types and styles of surround fields may be depicted and are within the scope of the present invention. One skilled in the art will recognize that no particular surround field, nor method for obtaining cues related to the input stream, nor method for modeling or affecting the surround field is critical to the present invention. It should also be understood that an element of a surround field shall be construed to mean the surround field, or any portion thereof, including without limitation, a pixel, a collection of pixels, and a depicted image or object, or a group of depicted images or objects.

H. Utilizing Idle Display Area or Areas

As mentioned previously, in embodiments of the invention, a video display and surround visual field may be shown within the boundaries of a traditional display device such as a television set, computer monitor, laptop computer, portable device, gaming devices, and the like.

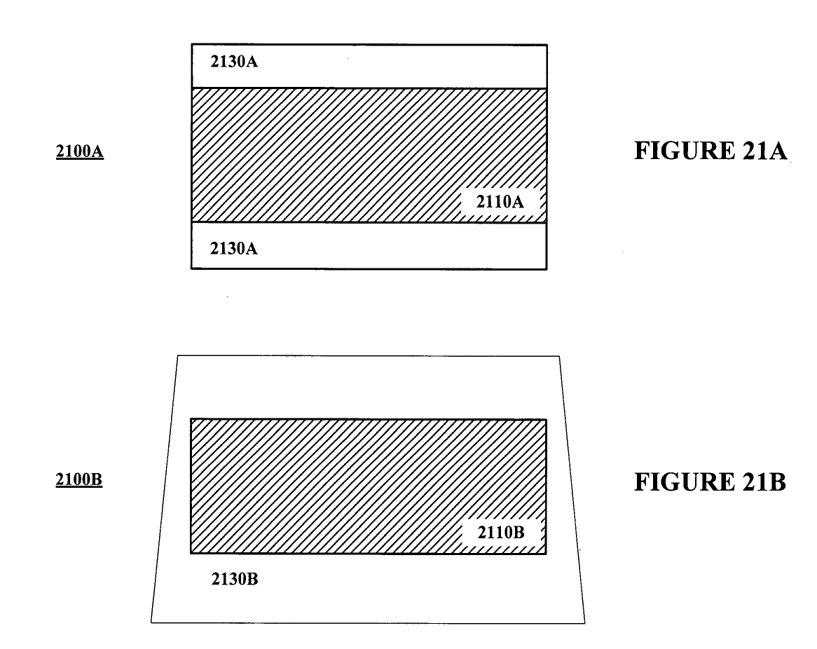

Traditional display devices, such as, for example, projectors, LCD panels, monitors, televisions, and the like, do not always utilize all of its display capabilities. FIGS. 21A and 21B illustrate two examples of idle display area, such as idle pixels, that exist when presenting content from an input stream 2110. FIG. 21A depicts a letterbox format input stream 2110A presented on a standard display 2100A. Because the video content aspect ratio differs from the display aspect ratio, there is unused display area 2130A at the top and bottom of the display 2100A. FIG. 21B depicts an image 2100B displayed, such as for example by a projector (not shown), on a wall. Common operations, such as key-stoning and zooming, create an area 2130B around the main display region 2110B that is unused, as shown in FIG. 21B. Accordingly, an aspect of the present invention involves utilizing this unused, or idle, display area 2130.

The present invention creates an immersive effect by utilizing the idle display area within a main display 2100. Embodiments of the present invention may employ some or all of the otherwise idle display area. In embodiments, a real-time interactive border may be displayed in the idle display area.

In embodiments, texture synthesis algorithms may be used for synthesizing borders to display in idle display areas. Texture synthesis algorithms, including but not limited to those described by Alexei A. Efros and William T. Freeman in “Image quilting for texture synthesis and transfer,” Proceedings of ACM SIGGRAPH 2001, Computer Graphics Proceedings, Annual Conference Series, pages 341-346, August 2001, and by Vivek Kwatra, Arno Schödl, Irfan Essa, Greg Turk, and Aaron Bobick in “Graphcut textures: Image and video synthesis using graph cuts,” ACM Transactions on Graphics, 22(3):277-286, July 2003, each of which is incorporated herein by reference in its entirety, may be employed. In embodiments, the synthesized borders may use color and edge information from the input video stream to guide the synthesis process. Moreover, the synthesized textures may be animated to respond to 2D motion vectors from the input stream, similar to the techniques described by Vivek Kwatra, Irfan Essa, Aaron Bobick, and Nipun Kwatra in “Texture optimization for example-based synthesis,” Proceedings of ACM SIGGRAPH 2005, which is incorporated herein by reference in its entirety. Other algorithms known to those skilled in the art may also be employed.

To enhance real-time performance, alternative embodiments may involve synthesizing a spatially extended image with borders for frames of an input video stream. Computer graphics techniques, including without limitation those techniques described above, may be employed to create an immersive border that responds in real-time to the input video stream.

In one embodiment, one aspect for utilizing the idle display area around the input frame may involve rendering a background plane illuminated by virtual light sources. In an embodiment, the colors of these virtual light sources may adapt to match one or more colors in the input stream. In an embodiment, the light sources may match one or more dominant colors in the input video stream.

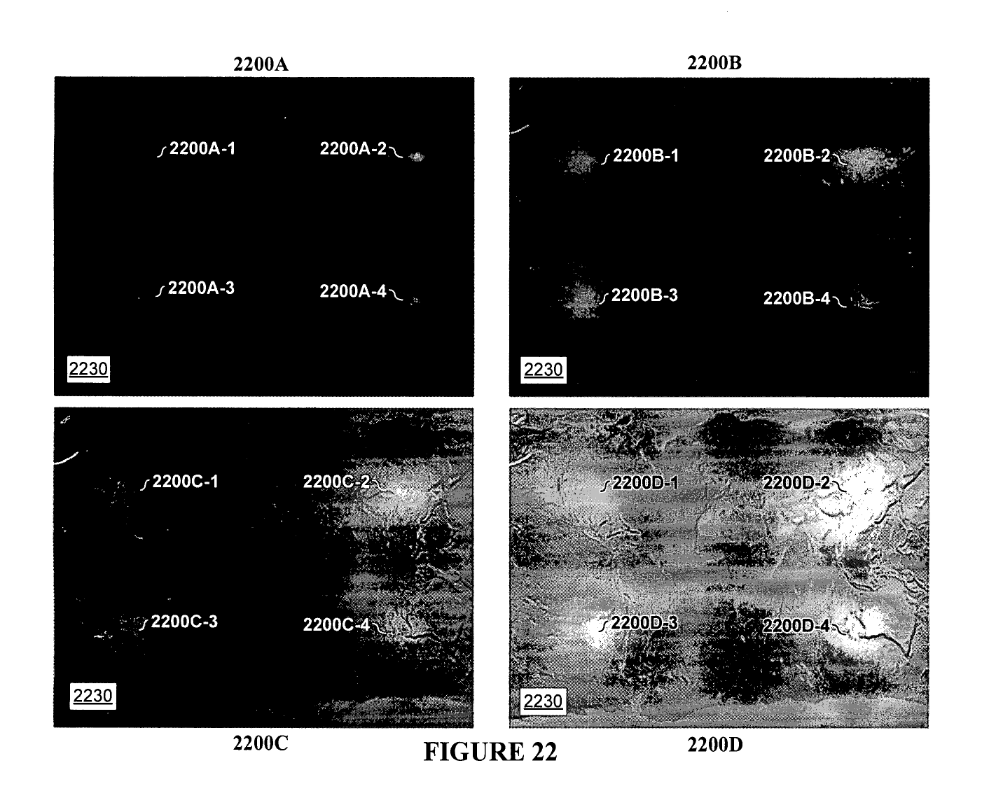

Consider by way of example, the bump-mapped background plate 2230 illuminated by four light sources 2200x-1-2200x-4 as depicted in FIG. 22. In an embodiment, the lighting at each point on the plane 2230 may be affected by a texture map and a normal map. The normal map, which is a two-dimensional height field, is used to perturb the surface normal, which affects how light shines off the surface. Bump maps are commonly used in computer games to create wrinkles or dimples on surfaces without the need of true three-dimensional models. In the illustrated embodiment, a set of four point light sources 2200x-1-2200x-4 are used. In an embodiment, the location of the light sources may correspond to the four corners of the input video. It shall be noted that no number or configuration of light sources is critical to the present invention.

In embodiments, the appearance of the background plate may be affected by one or more light sources. In the illustrated example, the background plate reflects the light from the sources as the light sources are moved closer to it. For example, in 2200A, the light sources 2200A-1-2200A-4 are remote from the plate 2230. Accordingly, the light sources 2200A-1-2200A-4 appear as smaller point light sources of limited brightness. As the light sources are virtually moved closer to the plate 2230, it is more brightly illuminated. It should be noted that the light pattern change; that the bump-mapping causes shadows to appear in regions of depth discontinuity (for example, near the edges of the continents); that the color of the map may also be affected; and that the light sources 2200x-1-2200x-4 may be moved independently. In embodiments, the color of the light sources may adjust to relate with the colors of the input stream.

The colors of each light 2200x-1-2200x-4 may be obtained by sampling a portion of the input image near the corner and computing the median color. In embodiments, simple heuristics may be used to determine color changes. In other embodiments, more sophisticated sampling schemes, including without limitation Mean Shift, may be used for assigning the color of the light sources 2200x-1-2200x-4.

In an embodiment, to synthesize the background images, the present invention may implement diffuse and specular lighting in addition to self-shadowing and bump mapping. The background images in FIG. 22 depict examples of surround visual fields synthesized utilizing diffuse and specular lighting in addition to self-shadowing and bump mapping.

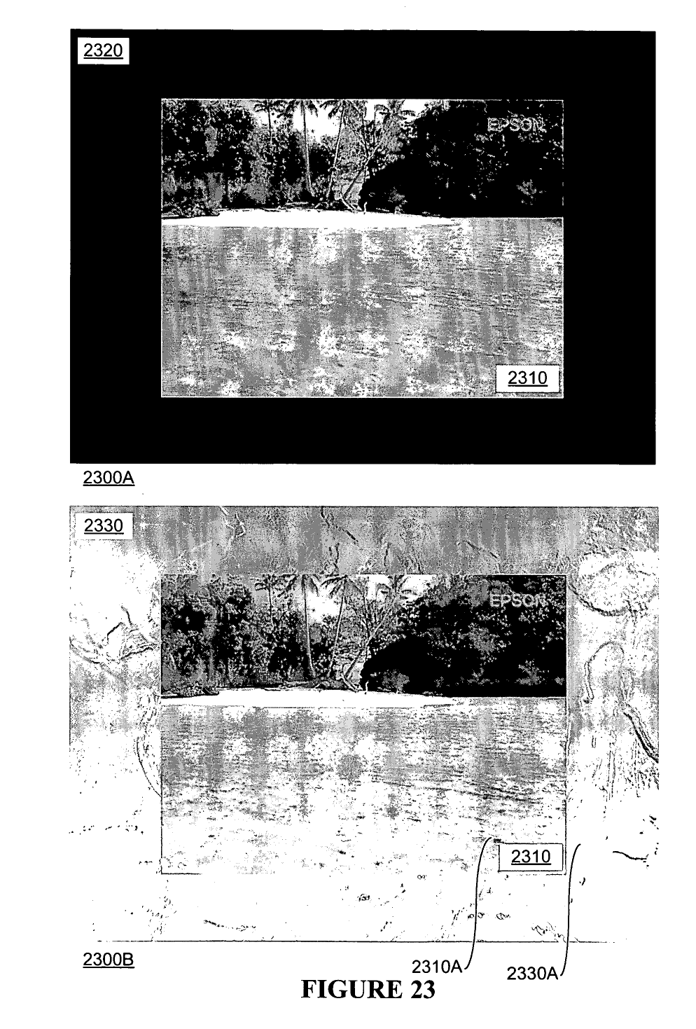

FIG. 23 depicts the results of a bump-map surround visual field border illuminated by point light sources for an input image 2310. The display 2300A comprises the input stream image 2310, which depicts a nature scene, and a portion of the display area 2320 that is idle. Utilizing a bump-mapped textured background that is lighted with lights taking their brightness and color from a portion of the input stream image 2310, a surround visual field 2330 may be generated and presented in the otherwise idle display area 2320 to improve the immersive effect. Controls signals, or cues, may be extracted from the input image 2310 to enhance the surround visual field by having the color and/or intensity relate to portions of the input stream image 2310. For example, areas of the surround visual field 2330A near a light section of the image 2310A may be related in color and intensity. As illustrated in FIG. 23, the bump-mapped background with self-shadows significantly improves the sense of immersion for the display 2300B since the lights and shadows expand the viewing area and respond dynamically to the input video stream. The depicted images were generated in real-time and implemented on a NVIDIA 6800 graphics processor using the Direct3D HLSL shading language.

In embodiments, the surround visual field displayed in the otherwise idle display area may be used to create mood lighting, which may be altered or change based upon one or more control signals extracted from the input stream. Alternatively, the surround visual field displayed in the otherwise idle display area may have a custom border, which may be authored or generated. For example, the border may contain logos, text, characters, graphics, or other items. Such items may be related to the input stream and may be altered or changed based upon one or more control signals extracted from the input stream.

It shall be noted that utilizing otherwise idle display area in a display to display a surround visual field is not limited to the embodiment disclosed herein. The surround visual field, shown within the boundaries of the display device, may employ any or all of the apparatuses or methods discussed previous, including without limitation, various content or effects, such as motion, images, patterns, textures, text, characters, graphics, varying color, varying numbers of light sources, three-dimensional synthesizing of the surround visual field, and other content and effects. Likewise, any of the embodiments described in relation to utilizing idle display area may also be employed by the surround visual field methods and systems, including those mentioned herein.

It shall be noted that embodiments of the present invention may further relate to computer products with a computer-readable medium that have computer code thereon for performing various computer-implemented operations. The media and computer code may be those specially designed and constructed for the purposes of the present invention, or they may be of the kind known or available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application-specific integrated circuits (ASICs), programmable logic devices (PLDs), flash memory devices, and ROM and RAM devices. Examples of computer code include machine code, such as produced by a compiler, and files containing higher level code that are executed by a computer using an interpreter.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

We claim:

1. A method for utilizing an idle display area of a display device, which idle display area would otherwise be unused when displaying an input stream, the method comprising:
extracting a cue from an input source;
generating a surround visual field comprising a plurality of elements, wherein at least one element within the surround visual field is affected by the cue; and
displaying the surround visual field using at least some of the idle display area of the display device.

2. The method of claim 1 wherein the cue is extracted from at least one input source selected from the group comprising: video data, audio data, game controller, input device, remote control, sensor, and authored cue.

3. The method of claim 2 wherein the step of generating a surround visual field comprising a plurality of elements, wherein at least one element within the surround visual field is affected by the cue comprises the steps of:
using a motion model in connection with the cue to approximate motion from the input stream; and
having the at least one element within the surround visual field move in relation to the motion model.

4. The method of claim 3 wherein the motion model is an affine motion model.

5. The method of claim 2 wherein the step of generating a surround visual field comprising a plurality of elements, wherein at least one element within the surround visual field is affected by the cue comprises the step of:
using a physics-based model to affect the at least one element in a realistic manner.

6. The method of claim 2 wherein the surround visual field comprises a background plane illuminated by a virtual light source.

7. The method of claim 6 wherein the background plane is a bump-mapped plane and the lighting on the background plane is related to a texture map and a normal map.

8. The method of claim 6 further comprising the step of:
positioning a virtual light source at or near each corner of a frame of the input stream.

9. The method of claim 8 wherein the step of extracting a cue from an input source comprises the step of:
determining the colors of each of the virtual light sources by sampling a portion of the frame.

10. A computer-readable medium carrying one or more sequences of instructions which, when executed by one or more processors, cause the one or more processors to perform at least the steps of the method of claim 1.

11. A surround visual field system comprising:
a surround visual field controller that obtains at least one control signal related to an input stream and generates a surround visual field comprising a plurality of elements, wherein at least one element within the surround visual field is affected by the control signal; and
a display device, communicatively coupled to the surround visual field controller, that displays the input stream in a first area of the display device and displays the surround visual field in at least a portion of the second area of the display device that would otherwise be idle.

12. The system of claim 11 wherein the at least one control signal is obtained from at least one source selected from the group comprising: video data, audio data, game controller, input device, remote control, sensor, and authored cue.

13. The system of claim 11 wherein the surround visual field comprises a background plane illuminated by a virtual light source.

14. The system of claim 13 wherein the color of the virtual light source is obtained from a control signal obtained by sampling a portion of the input stream.

15. The system of claim 13 wherein surround visual field controller uses a motion model to approximate motion from the control signal.

16. The system of claim 11 wherein at least a portion of the content of the surround visual field is authored.

17. A surround visual field controller comprising:
a control signal extractor, coupled to receive an input source related to an input stream displayed in a first area of a display device, that derives at least one control signal from the input source; and
a surround visual field generator, coupled to the control signal extractor, that receives the at least one control signal and generates a surround visual field for displaying in at least a portion of a second area of the display device that would otherwise be idle, said surround visual field comprising a plurality of elements, wherein at least one element within the surround visual field is affected by the control signal.

18. The surround visual field controller of claim 17 wherein the input source is at least one selected from the group comprising: video data, audio data, game controller, input device, remote control, sensor, and authored cue.

19. The controller of claim 17 wherein the surround visual field comprises a background plane illuminated by a virtual light source.

20. The system of claim 19 wherein the color of the virtual light source is obtained from a control signal obtained by sampling a portion of the input stream.
